(19) United States
(12) Patent Application Publication
(10) Pub. No.: US 2007/0023520 A1
(43) Pub. Date: Feb. 1, 2007

(54) Contactless reader/writer

(75) Inventor: Norihiro Miyashita, Ikoma-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 10/568,499

(22) PCT Filed: Apr. 21, 2005
(86) PCT No.: PCT/JP05/08101

§ 371 Date: Feb. 16, 2006

(30) Foreign Application Priority Data
Apr. 22, 2004 (JP) 2004-126588

(51) Int. Cl. G06K 7/08

(52) U.S. Cl. 235/451

(57) ABSTRACT

It is an object of the invention to provide a contactless reader/writer comprising a transmission section for transmitting a plurality of transmission signals using carrier waves of different frequencies, a reception section for receiving a plurality of reply signals which are a response to a plurality of transmission signals transmitted by the transmission section, a phase calculation section for calculating phase data of the reply signals on the basis of the reply signals, a distance calculation section for calculating a distance to an object having returned the reply signal, on the basis of the phase data from the phase calculation section and/or a speed calculation section for calculating a frequency component of baseband signals on the basis of the baseband signals acquired from the received signal, and thereby calculating a traveling speed of an object having returned the reply signal on the basis of the frequency component, and a control section for controlling a transmission direction of the transmission signals transmitted from the transmission section.

### FIELD OF THE INVENTION

The present invention relates to a contactless reader/writer for communicating with contactless type information storage carriers such as RF (radio frequency) tags and RF cards.

### BACKGROUND INFORMATION

In the communication of a contactless reader/writer with RF tags and RF cards serving as contactless type information storage carriers, the communication environment can vary depending on the situation. Such communication environment includes the positions, the speeds, and the number of the contactless type information storage carriers, as well as the arrangement of obstacles in the surroundings. Thus, ideal communication quality is achieved when the entire system of the contactless reader/writer such as the parameters of a transmission and reception section in the contactless reader/writer, the communication procedure, and the area of communication is optimized in real time depending on the communication environment.

As a first step for realizing this, real-time recognition of the detailed communication environment is needed that includes the positions, the speeds, and the number of contactless type information storage carriers as well as the arrangement of obstacles in the surroundings.

In the related art, a contactless reader/writer such as one disclosed in JP-T-2002-525640 (the term “JP-T” as used herein means a published Japanese translation of a PCT patent application) is known that can detect the distance between a contactless type information storage carrier and the contactless reader/writer.

FIG. 20 is a configuration diagram of a general contactless reader/writer according to the related art. In FIG. 20, numeral 81 indicates an RF tag serving as an example of a contactless type information storage carrier. Numeral 82 indicates a contactless reader/writer for performing wireless communication with the RF tag 81. Numeral 83 indicates a CPU (Central Processing Unit) for performing the output of transmission data, the processing of received data, and the like. Numeral 84 indicates a transmission section for processing the transmission data inputted from the CPU 83 and thereby outputting the data as a radio wave. Numeral 85 indicates a reception section for processing a radio wave received through an antenna section 86 and thereby outputting the received data to the CPU 83. Numeral 86indicates the antenna section for outputting as a radio wave the transmission signal inputted from the transmission section 84, and outputting the radio wave received from the RF tag 81 to the reception section 85 as a received signal.

This contactless reader/writer 82 has not employed a new transmission and reception circuit for distance detection. Thus, the distance to the RF tag 81 has been measured by a simple method by the CPU 83 on the basis of a response time and a received power from the contactless type information storage carrier obtained in the communication with the contactless type information storage carrier.

Nevertheless, such distance measurement in the related art contactless reader/writer has problems, for example, that merely a poor resolution is achieved in the calculation based on the response time from the contactless type information storage carrier and that a secondary echo occurs. Further, in the calculation based on the received power from the contactless type information storage carrier, a problem arises, for example, that the received power does not necessarily correspond to the distance because the received power varies depending on a change in the orientation and the like of the contactless type information storage carrier.

Further, although the distance to the contactless type information storage carrier is detectable, a detailed communication environment such as the direction, the speed, and the number, as well as the arrangement of obstacles in the surroundings cannot be recognized. Thus, no system has been constructed that is optimized in real time depending on the communication environment.

### SUMMARY OF THE INVENTION

An object of the invention is to provide a contactless reader/writer capable of detecting the positions, the speeds, and the number of contactless type information storage carriers, as well as the arrangement of obstacles in the surroundings.

In order to resolve the above-mentioned object, a contactless reader/writer according to the invention comprises a transmission section for transmitting a plurality of transmission signals using carrier waves of different frequencies; a reception section for receiving a plurality of reply signals which are a response to a plurality of transmission signals transmitted by the transmission section; a phase calculation section for calculating phase data of the reply signals on the basis of the reply signals; and a distance calculation section for calculating a distance to an object having returned the reply signal, on the basis of the phase data from the phase calculation section.

A contactless reader/writer according to the invention comprises a transmission section for transmitting a plurality of transmission signals using carrier waves of different frequencies; a reception section for receiving a plurality of reply signals which are a response to a plurality of transmission signals transmitted by the transmission section; a phase calculation section for calculating phase, data of the reply signals on the basis of the reply signals; and a speed calculation section for calculating a frequency component of baseband signals on the basis of the baseband signals acquired from the received signal, and thereby calculating a traveling speed of an object having returned the reply signal on the basis of the frequency component.

A contactless reader/writer according to the invention comprises a transmission section for transmitting a plurality of transmission signals using carrier waves of different frequencies; a reception section for receiving a plurality of reply signals which are a response to a plurality of transmission signals transmitted by the transmission section; a phase calculation section for calculating phase data of the reply signals on the basis of the reply signals; and a distance calculation section for calculating a distance to an object having returned the reply signal, on the basis of the phase data from the phase calculation section; wherein whether the object is an RF tag or an obstacle is determined on the basis of whether data is contained in the reply signal or not.

A contactless reader/writer according to the invention comprises a transmission section for transmitting a plurality of transmission signals using carrier waves of different frequencies; a reception section for receiving a plurality of reply signals which are a response to a plurality of transmission signals transmitted by the transmission, section; a phase calculation section for calculating phase data of the reply signals on the basis of the reply signals; and a speed calculation section for calculating a frequency component of baseband signals on the basis of the baseband signals acquired from the received signal, and thereby calculating a traveling speed of an object having returned the reply signal on the basis of the frequency component; wherein whether the object is an RF tag or an obstacle is determined on the basis of whether data is contained in the reply signal or not.

A contactless reader/writer according to the invention comprises a transmission section for transmitting a plurality of transmission signals using carrier waves of different frequencies; a reception section for receiving a plurality of reply signals which are a response to a plurality of transmission signals transmitted by the transmission section; a phase separation section for separating a phase component from each of a plurality of the received signals; and a distance calculation section for calculating a distance to an object having returned the reply signals, on the basis of the phase components of a plurality of received signals separated by the phase separation section.

A contactless reader/writer according to the invention comprises a transmission section for transmitting a plurality of transmission signals using carrier waves of different frequencies; a reception section for receiving a plurality of reply signals which are a response to a plurality of transmission signals transmitted by the transmission section; a phase separation section for separating a phase component from each of a plurality of the received signals; and a speed calculation section for calculating a frequency component of baseband signals on the basis of the baseband signals acquired from the received signal, and thereby calculating a traveling speed of an object having returned the reply signals, on the basis of the frequency component.

A contactless reader/writer according to the invention comprises a transmission section for transmitting a plurality of transmission signals using carrier waves of different frequencies; a reception section for receiving a plurality of reply signals which are a response to a plurality of transmission signals transmitted by the transmission section; a phase calculation section for calculating phase data of the reply signals on the basis of the reply signals; a data extraction section for receiving an output of the phase calculation section; and a distance calculation section for calculating a distance to an object having returned the reply signal, on the basis of the output data of the phase calculation section and a phase detection signal outputted from the data extraction section.

A contactless reader/writer according to the invention comprises a transmission section for transmitting a plurality of transmission signals using carrier waves of different frequencies; a reception section for receiving a plurality of reply signals which are a response to a plurality of transmission signals transmitted by the transmission section; a phase calculation section for calculating phase data of the reply signals on the basis of the reply signals; a data extraction section for receiving an output of the phase calculation section; and a speed calculation section for calculating a frequency component of baseband signals on the basis of the baseband signals acquired from the received signal, and thereby calculating a traveling speed of an object having returned the reply signal on the basis of the frequency component.

A contactless reader/writer according to the invention comprises a transmission section for transmitting one transmission signal in which a carrier frequency is continuously changed as a function of time; a reception section for receiving a reply signal which is a response to the transmission signal transmitted by the transmission section; and a distance calculation section for calculating a frequency component of baseband signals on the basis of the baseband signals acquired from the received signal, then calculating a difference frequency between a frequency of the transmission signal and a frequency of the received signal on the basis of the frequency component, and thereby calculating a distance to an object having returned the reply signal on the basis of the difference frequency component.

A contactless reader/writer according to the invention comprises a transmission section for transmitting one transmission signal in which a carrier frequency is continuously changed as a function of time; a reception section for receiving a reply signal which is a response to the transmission signal transmitted by the transmission section; and a speed calculation section for calculating a frequency component of baseband signals on the basis of the baseband signals acquired from the received signal, then calculating a difference frequency between a frequency of the transmission signal and a frequency of the received signal on the basis of the frequency component, and thereby calculating a traveling speed of an object having returned the reply signal on the basis of the difference frequency component.

As described above, a contactless reader/writer according to the invention comprises a phase separation section and a distance calculation section or a speed calculation section, and thereby is capable of detecting the position and the speed of an object.

### BRIEF DESCRIPTION OF THE DRAWINGS

FIG. 1 is a block diagram showing the schematic configuration of a communication system for RF tags according to Embodiment 1 of the invention;

FIG. 2 is a block diagram showing the schematic configuration of a communication system for RF tags according to Embodiment 2 of the invention;

FIG. 3 is a block diagram showing the schematic configuration of a communication system for RF tags according to Embodiment 3 of the invention;

FIG. 4 is a wave form diagram for explaining a beat frequency according to Embodiment 4 of the invention;

FIG. 5 is a block diagram showing the schematic configuration of a communication system for RF tags according to Embodiment 4 of the invention;

FIG. 6 is a diagram showing an example of an array antenna according to Embodiment 5 of the invention;

FIG. 7 is a diagram showing an example of an array antenna according to Embodiment 6 of the invention;

FIG. 8 is a diagram showing the schematic configuration of a communication system for RF tags according to Embodiment 7 of the invention;

FIG. 9A is a diagram showing the relation between the distance of an RF tag relative to a contactless reader/writer and the received signal power from the RF tag according to Embodiment 8 of the invention; FIG. 9B is a diagram showing the relation between the distance of an RF tag relative to a contactless reader/writer and the gain of a transmission amplifier according to Embodiment 8 of the invention; and FIG. 9C is a diagram showing the relation between the distance of an RF tag relative to a contactless reader/writer and the received signal power from the RF tag after optimization according to Embodiment 8 of the invention;

FIG. 10A is a diagram showing the relation between the distance of an RF tag relative to a contactless reader/writer and the received signal power from the RF tag according to Embodiment 9 of the invention; FIG. 10B is a diagram showing the relation between the distance of an RF tag relative to a contactless reader/writer and the gain of a transmission amplifier according to Embodiment 9 of the invention; and FIG. 10C is a diagram showing the relation between the distance of an RF tag relative to a contactless reader/writer and the received signal power from the RF tag after optimization according to Embodiment 9 of the invention;

FIG. 11A is a diagram showing the relation between the distance of an RF tag relative to a contactless reader/writer and the received signal power from the RF tag according to Embodiment 10 of the invention; and FIG. 11B is a diagram showing the relation between the distance of an RF tag relative to a contactless reader/writer and the received signal power from the RF tag after optimization according to Embodiment 10 of the invention;

FIG. 12 is a diagram showing the bit error rate in multiphase PSK according to Embodiment 11 of the invention.

FIG. 13 is a diagram showing an example of correspondence between the RF tag speed and the modulation method according to Embodiment 11 of the invention;

FIG. 14 is a diagram showing an example of correspondence between the RF tag speed and the packet size according to Embodiment 12 of the invention;

FIG. 15 is a diagram showing the PSK bit error rate and a bit error rate obtained when error-correction code coding is performed on the PSK according to Embodiment 13;

FIG. 16 is a diagram showing the schematic configuration of a communication system for RF tags according to Embodiments 14 through 20 of the invention;

FIG. 17 is a configuration diagram showing the schematic configuration of a communication system for RF tags according to Embodiment 21 of the invention;

FIG. 18 is a diagram showing an example of display in a display unit according to Embodiment 21 of the invention;

FIG. 19 is a configuration diagram showing the schematic configuration of a communication system for RF tags according to Embodiment 22 of the invention; and

FIG. 20 is a configuration diagram of a general contactless reader/writer according to the related art.

### BEST MODE FOR CARRYING OUT THE INVENTION

(Embodiment 1)

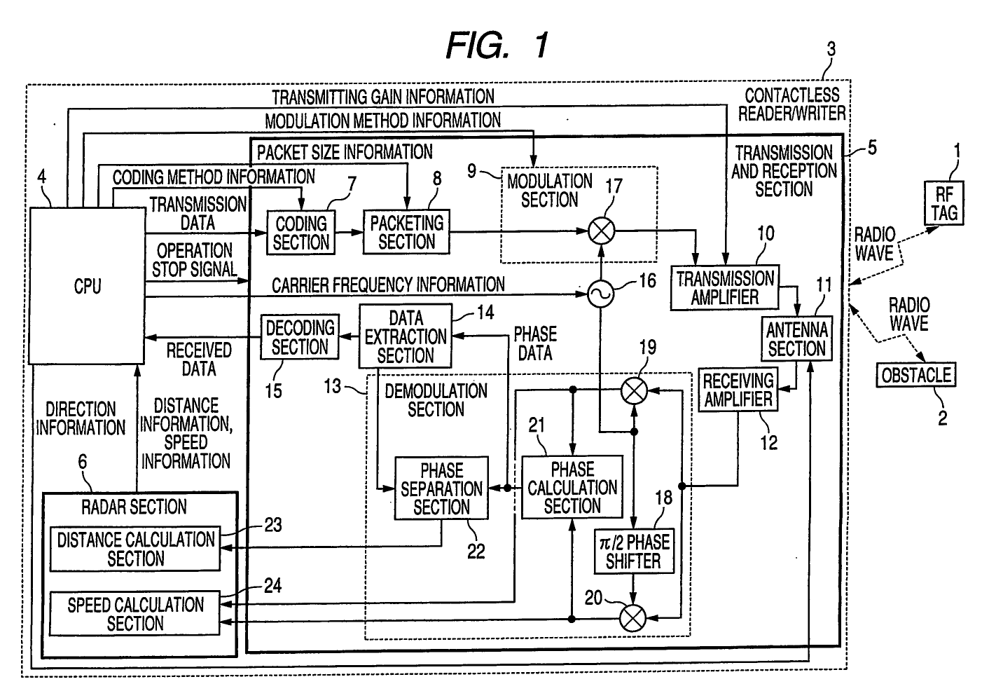

FIG. 1 is a diagram showing the schematic configuration of a communication system comprising an RF tag 1 and a contactless reader/writer 3 for communicating with the RF tag 1. In FIG. 1, numeral 1 indicates the RF tag serving as an example of a contactless type information storage carrier. Numeral 2 indicates an obstacle present around the RF tag 1. Although only one obstacle is shown in FIG. 1, it represents all of the objects except for the RF tag 1 serving as the communication target. Numeral 3 indicates a contactless reader/writer for performing wireless communication with the RF tag 1.

The configuration of the contactless reader/writer 3 is described below.

Numeral 4 indicates a CPU for outputting transmission data to be transmitted to the RF tag 1 and the like and processing received data from the RF tag 1 or the like, as well as controlling the operation of a transmission and reception section 5 as described later. Numeral 5 indicates the transmission and reception section for processing the transmission data inputted from the CPU 4 and then outputting the data as a radio wave. The transmission and reception section also processes a radio wave received from the RF tag 1 or the like, and then outputs the received data to the CPU 4. Numeral 6 indicates a radar section for calculating the distance and the speed of the RF tag 1 or the obstacle 2 on the basis of data outputted from a phase separation section 22 provided in the transmission and reception section 5 as described later and on the basis of baseband signals outputted from a mixer 19 and a mixer 20. This radar section outputs the result to the CPU 4. Incidentally, the radar section 6 comprises a distance calculation section 23 for calculating the distance to the RF tag 1 or the obstacle 2; and a speed calculation section 24 for calculating the traveling speed of the RF tag 1 or the obstacle 2.

Next, the configuration of the transmission and reception section 5 in the contactless reader/writer 3 is described below.

Numeral 7 indicates a coding section for coding the transmission data inputted from the CPU 4 and then outputting the data to a packeting section 8. Numeral 8 indicates the packeting section for converting the coded data inputted from the coding section 7 into a packet and then outputting the packet to a modulation section 9. Numeral 9 indicates the modulation section for modulating the packet data inputted from the packeting section 8 and then outputting this modulation signal to a transmission amplifier 10. This modulation section comprises a mixer 17. Two of such mixers 17 may be provided so as to constitute a quadrature modulator.

Numeral 10 indicates the transmission amplifier for amplifying the modulation signal inputted from the modulation section 9 and then outputting the signal as a transmission signal to an antenna section 11. Numeral 11 indicates the antenna section for outputting the transmission signal inputted from the transmission amplifier 10, as a radio wave toward the RF tag 1 or obstacle 2. The antenna section also outputs a radio wave received from the RF tag 1 or the obstacle 2, as a received signal to a receiving amplifier 12. Numeral 12 indicates the receiving amplifier for amplifying the received signal inputted from the antenna section 11 and then outputting the signal to a demodulation section 13. Numeral 13 indicates the demodulation section for performing orthogonal detection and demodulation on the received signal inputted from the receiving amplifier 12 and then outputting phase data to a data extraction section 14 and outputting a phase change component and baseband signals to the radar section 6. This demodulation section 13 comprises a phase shifter 18, mixers 19 and 20, a phase calculation section 21, and a phase separation section 22.

Numeral 14 indicates the data extraction section for removing a packet header from the phase data inputted from the demodulation section 13, thereby extracting data, and then outputting the data to a decoding section 15. Numeral 15 indicates the decoding section for decoding the data inputted from the data extraction section 14 and then outputting as received data the decoded data to the CPU 4.

Numeral 16 indicates an oscillator for outputting a carrier signal of a frequency specified by the CPU 4, to the modulation section 9 and the demodulation section 13.

Next, the configuration of the modulation section 9 is described below in detail. The mixer 17 provided in the modulation section 9 multiplies the packet data inputted from the packeting section 8 and the carrier signal inputted from the oscillator 16, thereby performs frequency conversion on the packet data into the pass band, and then outputs the signal to the transmission amplifier 10.

Next, the configuration of the demodulation section 13 is described below in detail. The phase shifter 18 performs phase shift on the carrier signal inputted from the oscillator 16 by Π/2 radian. The mixer 19 multiplies the received signal inputted from the receiving amplifier 12 and the carrier signal inputted from the oscillator 16, thereby performs frequency conversion on the received signal into the baseband, and then outputs the signal to the phase calculation section 21 and the speed calculation section 24. The mixer 20 multiplies the received signal inputted from the receiving amplifier 12 and the Π/2-radian phase shifted carrier signal inputted from the phase shifter 18, thereby performs frequency conversion on the received signal into the baseband, and then outputs the signal to the phase calculation section 21 and the speed calculation section 24. The phase calculation section 21 calculates the phase of the baseband signals on the basis of the in-phase component and the quadrature component of the baseband signals outputted from the mixer 19 and the mixer 20, and then outputs the phase data to the data extraction section 14 and the phase separation section 22. The phase separation, section 22 extracts the phase change component from the phase data inputted from the phase calculation section 21, and then outputs the signal to the distance calculation section 23 in the radar section 6.

Next, the radar section 6 is described below in detail. On the basis of the phase change component outputted from the phase separation section 22 in the transmission and reception section 5, the distance calculation section 23 calculates the distance from the contactless reader/writer 3 to the RF tag 1 or the obstacle 2. On the basis of the baseband signals outputted from the mixer 19 and the mixer 20, the speed calculation section 24 calculates the traveling speed of the RF tag 1 or the obstacle 2.

The operation is described below for the communication system for RF tags having the above-mentioned configuration.

In the contactless reader/writer 3, two transmission signals using carrier waves of mutually different frequencies are outputted from the antenna section 11. These two transmission signals are transmitted not simultaneously but at different times. This is because if the RF tag 1 would receive a plurality of signals simultaneously, interference could occur so that normal signals could not be returned to the contactless reader/writer 3.

The transmission data outputted from the CPU 4 for the transmission to the RF tag 1 is coded by the coding section 7. Then, the coded data is converted into a packet by the packeting section 8, and then processed by pass band modulation in the modulation section 9. When the amplitude of the signal E1 is denoted by AS1, the phase by S1, and the carrier angular frequency by ω1, and when the amplitude of the signal E2 is denoted by AS2, the phase by S2, and the carrier angular frequency by ω2, the two signals E1 and E2 processed by pass band modulation in the modulation section 9 are expressed by (Equation 1) and (Equation 2). The two signals are modulated with different carrier angular frequencies. Further, the signal information to be transmitted to the RF tag 1 is contained in AS1 and AS2 in the case of amplitude modulation, and in S1 and S2 in the cases of phase modulation and frequency modulation, it is contained.
E₁=Aₛ_{₁} cos(ω₁t+s₁) [Equation 1]
E₂=Aₛ_{₂} cos(ω₂t+s₂) [Equation 2]

These two signals E1 and E2 are amplified by the transmission amplifier 10, and then radiated from the antenna section 11. The signals radiated from the antenna section 11 are reflected by the RF tag 1 or the obstacle 2. The reflected signals are received by the antenna section 11. Then, the signals received by the antenna section 11 are amplified by the receiving amplifier 12.

Described below first is the case that the signals are reflected by the RF tag 1.

The round trip distance of the radio waves between the contactless reader/writer 3 and the RF tag 1 is denoted by Z. The Doppler angular frequency generated by the motion of the RF tag 1 is denoted by ωd. As for the two signals E1 and E2 modulated by the RF tag 1, the amplitude of the signal E1 is denoted by AS1′, the phase by S1′, and the propagation constant k1, the amplitude of the signal E2 is denoted by AS2′, the phase by S2′, and the propagation constant by k2. Then, the received signals reflected by the RF tag 1 are expressed by (Equation 3) and (Equation 4). The modulation method in the RF tag 1 is assumed to be phase modulation or frequency modulation.
E₁=Aₛ_{₁}′ cos((ω₁±ω₁)t−k₁z+s₁′) [Equation 3]
E₂=Aₛ_{₁}′ cos((ω₂±ω_{d})t−k₂z+s₂′) [Equation 4]

Here, when the values of the carrier angular frequencies ω1 and ω2 are very close to each other, their Doppler angular frequencies also become approximately equal. Thus, in (Equation 3) and (Equation 4), the Doppler angular frequencies are set to be ωd. The received signals amplified by the receiving amplifier 12 are processed by orthogonal detection in the demodulation section 13, and thereby frequency-converted into the base band. These obtained signals are expressed by (Equation 5), (Equation 6), (Equation 7), and (Equation 8). Here, the in-phase component of E1 is denoted by E1I, the quadrature component by E1Q, the in-phase component of E2 by E2I, and the quadrature component by E2Q.
E_{1I}=Aₛ_{₁}′ cos(±ω_{d}t−k₁z+s₁′) [Equation 5]
E_{1Q}=Aₛ_{₁}′ sin(±ω_{d}t−k₁z+s₁′) [Equation 6]
E_{2I}=Aₛ_{₂}′ cos(±ω_{d}t−k₂z+s₂′) [Equation 6]
E_{2Q}=Aₛ_{₂}′ sin(±ω_{d}t−k₂z+s₂′) [Equation 8]

When the phase constant is denoted by a and the attenuation coefficient by β, the propagation constant k is expressed by (Equation 9).
k=α−jβ [Equation 9]

The term of the attenuation coefficient is neglected here for simplicity. Then, when the phase constant of the signal El is denoted by α1, and the phase constant of the signal E2 by α2, (Equation 5), (Equation 6), (Equation 7), and (Equation 8) are rewritten as follows.
E_{1I}=Aₛ_{₁}′ cos(±ω_{d}t−α₁z+s₁′) [Equation 10]
E_{1Q}=Aₛ_{₁}′ sin(±ω_{d}t−α₁z+s₁′) [Equation 11]
E_{2I}=Aₛ_{₂}′ cos(±ω_{d}t−α₂z+s₂′) [Equation 12]
E_{2Q}=Aₛ_{₂}′ sin(±ω_{d}t−α₂z+s₂′) [Equation 13]

The baseband signals (Equation 10), (Equation 11), (Equation 12), and (Equation 13) are outputted to the phase calculation section 21. The phase calculation section 21 converts the baseband signals into polar coordinates, and thereby calculates the phases. The phase data θ1 of the signal E1 is expressed by (Equation 14), while the phase data θ2 of the signal E2 is expressed by (Equation 15).
θ₁=±ω_{d}t−α₁z+s₁′ [Equation 14]
θ₂=±ω_{d}t−α₂z+s₂′ [Equation 15]

As seen from (Equation 14) and (Equation 15), the Doppler effect of the RF tag 1 and the radio wave propagation generate phase change components in the received signals as shown in (Equation 16) and (Equation 17).
θ₁=±ω_{d}t−α₁z [Equation 16]
θ₂=±ω_{d}t−α₂z [Equation 17]

The phase calculation section 21 outputs the calculated phase data to the data extraction section 14. The data extraction section 14 extracts the signal components S1′ and S2′ of the phase data from the phase data θ1 and θ2, then performs data extraction using these data pieces as the phase data containing the identification information and the like of the RF tag 1, and then outputs the data to the decoding section 15. The decoding section 15 decodes the inputted data, and then,outputs the decoded data as the received data to the CPU 4.

The phase calculation section 21 outputs the calculated phase data θ1 and θ2 to the phase separation section 22. The data extraction section 14 outputs the signal components S1′ and S2′ of the phase data to the phase separation section 22. The phase separation section 22 subtracts the signal components S1′ and S2′ of the phase data from the phase data θ1 and θ2, thereby calculates the phase change components θ1′ and θ2′ , and then outputs the result to the distance calculation section 23 in the radar section 6.

The distance calculation section 23 calculates the difference of the two inputted phases. The phase difference is as shown in (Equation 18).
θ₁′−θ₂′=−(α₁−α₂)Z [Equation 18]

Here, when the carrier angular frequency is denoted by ω and the speed of the radio wave by C, the phase constant is expressed by (Equation 19).

$$α = \frac{ω}{c} \qquad [ Equation 19 ]$$

Thus, (Equation 18) is rewritten as shown in (Equation 20).
θ₁′−θ₂′−(ω₁−ω₂)Z/c [Equation 20]

Thus, the round trip distance Z of the radio wave between the contactless reader/writer 3 and the RF tag 1 becomes as shown in (Equation 21).

$$Z = - c \frac{{θ}_{1}^{′} - {θ}_{2}^{′}}{{ω}_{1} - {ω}_{2}} \qquad [ Equation 21 ]$$

Using (Equation 21), the distance calculation section 23 calculates the distance on the basis of the phase difference (Equation 18). The speed calculation section 24 calculates the Doppler frequency fd from the baseband signals (Equation 10), (Equation 11), (Equation 12), and (Equation 13) by using fast Fourier transform or the like.

When the wavelength of the carrier wave is denoted by λ,the relative velocityVbetween the RF tag 1 and the contactless reader/writer 3 is as shown in (Equation 22).

$$V = {f}_{d} \cdot \frac{λ}{2} \qquad [ Equation 22 ]$$

On the basis of the speed of the contactless reader/writer 3 itself and the Doppler frequency fd, the speed calculation section 24 calculates the speed of the RF tag 1.

Next, in the case that the transmission signals radiated from the contactless reader/writer 3 are reflected by the obstacle 2, (Equation 3) and (Equation 4) expressing the case that the signals are reflected by the RF tag 1 are modified into (Equation 23) and (Equation 24).
E₁=Aₛ_{₁} cos((ω₁±ω_{d})t−k₁z+s₁) [Equation 23]
E₂=Aₛ_{₂} cos((ω₂±ω_{d})t−k₂z+s₂) [Equation 24]

The employed calculation procedure for the distance, the speed, and the received data is similar to that of the case of the RF tag 1.

Here, for example, in the case that the carrier frequency is 950 MHz, the difference of the two phase change components is Π/4 radian, the frequency difference of the two carrier waves is 1 MHz, and the Doppler frequency is 100 Hz, then obtained are a distance of 37.5 m and a speed of 15.7 m/s.

Whether the reflected signals received in the contactless reader/writer 3 are caused by the RF tag 1 or by the obstacle 2 is determined in the CPU 4 by checking whether the received data inputted to the CPU 4 is the same as the transmitted data or not. When these data pieces are the same, the obstacle 2 is determined as the source. That is, when signals are received from the RF tag 1, the identification information of the RF tag1 and the like is contained in the reflected signals. Thus, the reflected signals from the RF tag 1 differ from the transmitted signals. Accordingly, when the transmission signals differ from the reflected signals, the reflected signals are determined as reflected by the RF tag 1. When the reflected signals are the same as the transmission signals, the reflected signals are determined as not from the RF tag 1 but from the obstacle 2.

As for the difference between the timings of transmitting and receiving the two signals using the carrier waves of mutually different frequencies, when the difference is smaller, the traveled distance of the target such as the RF tag 1 and the obstacle 2 becomes smaller. This improves the precision in the distance calculation.

As described above, in the case that the modulation method in the RF tag 1 supports phase modulation or frequency modulation, when the phase separation section 22, the distance calculation section 23, and the speed calculation section 24 are merely added to a general contactless reader/writer, the contactless reader/writer 3 capable of calculating the distance to the RF tag 1 or the obstacle 2 and the traveling speed of the RF tag 1 or the obstacle 2 is realized without the necessity of newly providing a special antenna or a special transmission and reception circuit for a dedicated radar for detecting the RF tag 1 and the like.

Further, the signals used here are those employed in the communication between the RF tag 1 and the contactless reader/writer 3. Thus, the distance to the RF tag 1 or the obstacle 2 and the traveling speed of the RF tag 1 or the obstacle 2 can be calculated during the normal communication with the RF tag 1.

In the present embodiment, two signals have been used that employ carrier waves of mutually different frequencies. However, the invention is not limited to this, and more than two signals may be used.

(Embodiment 2)

In the description of the present embodiment, like parts to Embodiment 1 are designated by like numerals, and hence detailed description is omitted. The difference from Embodiment 1 is that the phase separation section 22 is unnecessary.

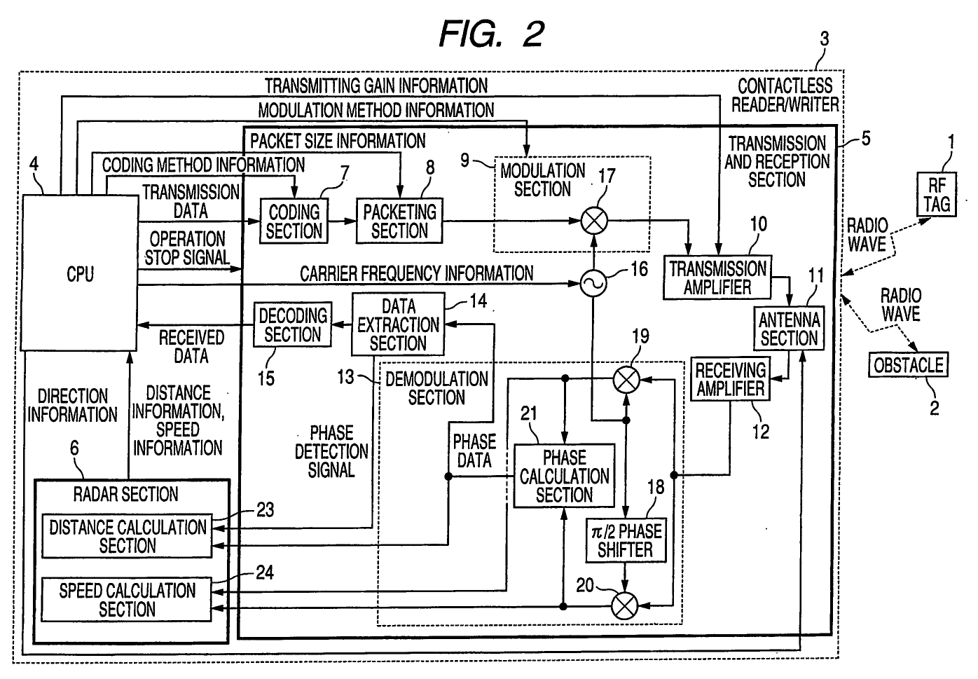

The difference in the present embodiment from Embodiment 1 is described below with reference to FIG. 2. The phase calculation section 21 outputs the calculated phase data θ1 and θ2 to the distance calculation section 23 in the radar section 6. When the signal components S1′ and S2′ of the phase data extracted from the phase data θ1 and θ2 have a fixed value such as Π radian, the data extraction section 14 outputs a phase detection signal to the distance calculation section 23 in the radar section 6.

At the timing that the phase detection signal is inputted, the distance calculation section 23 holds the phase data θ1 and θ2 inputted from the phase calculation section 21, and then calculates the difference. At that time, the signal components S1′ and S2′ of the phase data contained in the phase data θ1 and θ2 are identical, and hence the phase difference is as shown in (Equation 25).
θ₁−θ₂=−(α₁−α₂)Z [Equation 25]

This is the same result as (Equation 18). The employed procedure for calculating the distance on the basis of the phase difference is similar to that of Embodiment 1.

The employed procedure for calculating the speed and the received data is similar to that of Embodiment 1. The employed procedure for calculating the distance and the speed of the obstacle 2 as well as the received data is the same as the case of the RF tag 1.

As described above, in the case that the modulation method in the RF tag 1 supports phase modulation or frequency modulation, when the distance calculation section 23 and the speed calculation section 24 are merely added to a general contactless reader/writer, the contactless reader/writer 3 capable of calculating the distance to the RF tag 1 or the obstacle 2 and the traveling speed of the RF tag 1 or the obstacle 2 is realized without the necessity of newly providing a special antenna or a special transmission and reception circuit for a dedicated radar for detecting the RF tag 1 and the like.

Further, the signals used here are those employed in the communication between the RF tag 1 and the contactless reader/writer 3. Thus, the distance to the RF tag 1 or the obstacle 2 and the traveling speed of the RF tag 1 or the obstacle 2 can be calculated during the normal communication with the RF tag 1.

In the present embodiment, two signals have been used that employ carrier waves of mutually different frequencies. However, the invention is not limited to this, and more than two signals may be used.

(Embodiment 3)

In the description of the present embodiment, like parts to Embodiment 1 are designated by like numerals, and hence detailed description is omitted. The differences from Embodiment 1 are that amplitude modulation is used as the modulation method in the RF tag 1, that the phase separation section 22 is unnecessary, and that the phase calculation section 21 is replaced by an amplitude and phase calculation section 25.

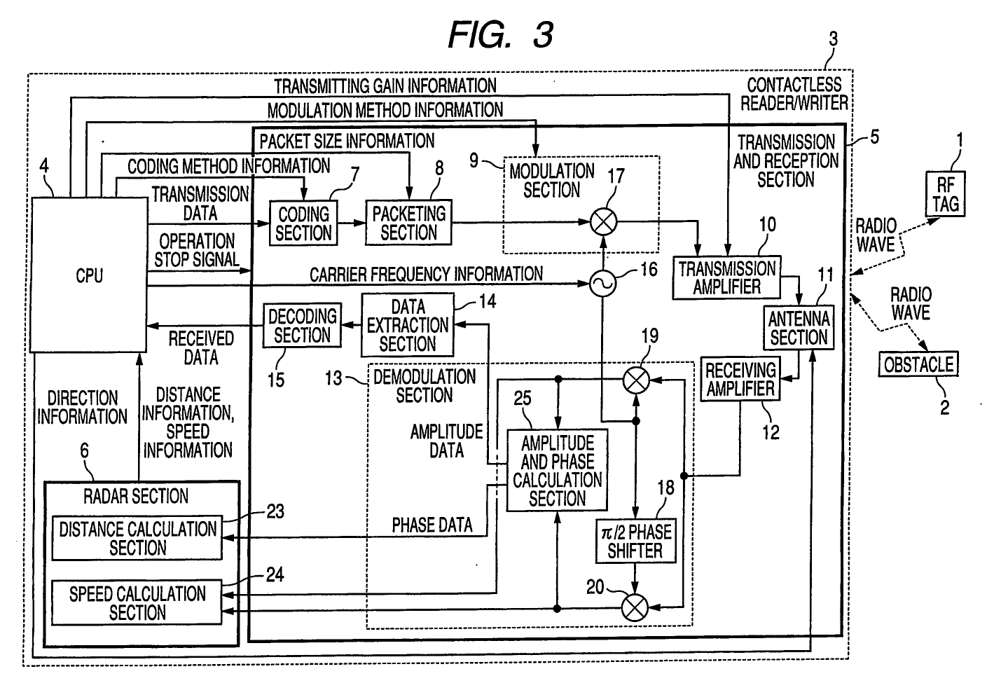

The differences of the present embodiment from Embodiment 1 are described below with reference to FIG. 3.

The amplitude and phase calculation section 25 calculates the amplitude and the phase of the baseband signals on the basis of the in-phase component and the quadrature component of the baseband signals outputted from the mixer 19 and the mixer 20, and then outputs the amplitude data to the data extraction section 14 and the phase data to the distance calculation section 23.

The operation is described below for the communication system for RF tags having this configuration.

The round trip distance of the radio waves between the contactless reader/writer 3 and the RF tag 1 is denoted by Z. The Doppler angular frequency generated by the motion of the RF tag 1 is denoted by ωd. As for the two signals E1 and E2 modulated by the RF tag 1, the amplitude of the signal E1 is denoted by AS1′ , the propagation constant by k1, while the amplitude of the signal E2 is denoted by AS2′ , the propagation constant by k2. Then, the received signals reflected by the RF tag 1 are expressed by (Equation 26) and (Equation 27). The modulation method in the RF tag 1 is assumed to be amplitude modulation.
E₁=Aₛ_{₁}′ cos((ω₁±ω_{d})t−k₁z) [Equation 26]
E₂=Aₛ_{₂}′ cos((ω₂±ω_{d})t−k₂z) [Equation 27]

Here, when the values of the carrier angular frequencies ω1 and ω2 are very close to each other, their Doppler angular frequencies also become approximately equal. Thus, in (Equation 26) and (Equation 27), the Doppler angular frequencies are set to be ωd.

The received signals amplified by the receiving amplifier 12 are processed by orthogonal detection in the demodulation section 13, and thereby frequency-converted into the base band. These obtained signals are expressed by (Equation 28), (Equation 29), (Equation 30), and (Equation 31). Here, the in-phase component of E1 is denoted by E1I, the quadrature component by E1Q, the in-phase component of E2 by E2I, and the quadrature component by E2Q.
E_{1I}=Aₛ_{₁}′ cos(±ω_{d}t−k₁z) [Equation 28]
E_{1Q}=Aₛ_{₁}′ sin(±ω_{d}t−k₁z) [Equation 29]
E_{2I}=Aₛ_{₂}′ cos(±ω_{d}t−k₂z) [Equation 30]
E_{2Q}=Aₛ_{₂}′ sin(±ω_{d}t−k₂z) [Equation 31]

When the phase constant is denoted by α and the attenuation coefficient by β, the propagation constant k is expressed by (Equation 32).
k=α−jβ [Equation 32]

Here, the term of the attenuation coefficient is neglected for simplicity. Then, when the phase constant of the signal El is denoted by α1, and the phase constant of the signal E2 by α2, (Equation 28), (Equation 29), (Equation 30), and (Equation 31) are rewritten as follows.
E_{1I}=Aₛ_{₁}′ cos(±ω_{d}t−α₁z) [Equation 33]
E_{1Q}=Aₛ_{₁}′ sin(±ω_{d}t−α₁z) [Equation 34]
E_{2I}=Aₛ_{₂}′ cos(±ω_{d}t−α₂z) [Equation 35]
E_{2Q}=Aₛ_{₂}′ sin(±ω_{d}t−α₂z) [Equation 36]

The baseband signals (Equation 33), (Equation 34), (Equation 35), and (Equation 36) are outputted to the amplitude and phase calculation section 25. The amplitude and phase calculation section 25 converts the baseband signals into polar coordinates, and thereby calculates the amplitudes and the phases. The amplitude of the signal E1 is AS1′ , while the amplitude of the signal E2 is AS2′ . The phase θ1 of the signal E1 is given by (Equation 37), while the phase θ2 of the signal E2 is given by (Equation 38).
θ₁=±ω_{d}t−α₁z [Equation 37]
θ₂=±ω_{d}t−α₂z [Equation 38]

The amplitude and phase calculation section 25 outputs the calculated amplitude data to the data extraction section 14. The data extraction section 14 performs data extraction by using the inputted amplitude data AS1′ and AS2′ as the amplitude data containing the identification information and the like of the RF tag 1, and then outputs the data to the decoding section 15. The decoding section 15 decodes the inputted data, and then outputs the decoded data as the received data to the CPU 4.

The amplitude and phase calculation section 25 outputs the calculated phase data to the distance calculation section 23 in the radar section 6.

The distance calculation section 23 calculates -the difference of the two inputted phases. The phase difference is as shown in (Equation 39).
θ₁−θ₂=−(α₁−α₂)Z [Equation 39]

The same value as (Equation 18) is obtained. The employed procedure for calculating the distance on the basis of the phase difference is similar to that of Embodiment 1.

The employed procedure for calculating the speed is similar to that of Embodiment 1. The employed procedure for calculating the distance and the speed of the obstacle 2 as well as the received data is the same as the case of the RF tag 1.

As described above, in the case that the modulation method in the RF tag 1 supports amplitude modulation, when the distance calculation section 23 and the speed calculation section 24 are merely added to a general contactless reader/writer, the contactless reader/writer 3 capable of calculating the distance to the RF tag 1 or the obstacle 2 and the traveling speed of the RF tag 1 or the obstacle 2 is realized without the necessity of newly providing a special antenna or a special transmission and reception circuit for a dedicated radar for detecting the RF tag 1 and the like.

Further, the signals used here are those employed in the communication between the RF tag 1 and the contactless reader/writer 3. Thus, the distance to the RF tag 1 or the obstacle 2 and the traveling speed of the RF tag 1 or the obstacle 2 can be calculated during the normal communication with the RF tag 1.

In the present embodiment, two signals have been used that employ carrier waves of mutually different frequencies.

However, the invention is not limited to this, and more than two signals may be used.

(Embodiment 4)

In the description of the present embodiment, like parts to Embodiment 1 are designated by like numerals, and hence detailed description is omitted. The differences from Embodiment 1 are: amplitude modulation is used as the modulation method in the RF tag 1; one transmission signal the carrier frequency of which is continuously changed as a function of time is used for calculating the distance to the RF tag 1 and the obstacle 2 from the contactless reader/writer 3 as well as the traveling speed of the RF tag 1 and the obstacle 2; the phase separation section 22 is unnecessary; and the phase calculation section 21 is replaced by an amplitude calculation section 26.

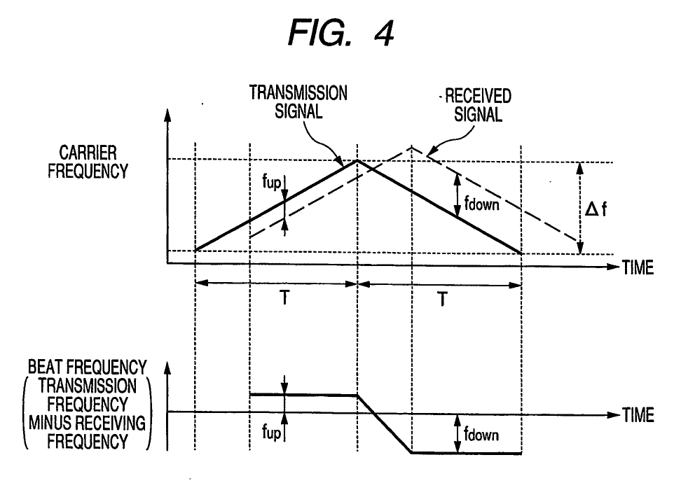

The present embodiment is described below with reference to FIG. 4.

FIG. 4 shows an example of the time relation of the carrier frequencies of the transmission signal and the received signal as well as the beat frequency (frequency difference of the transmission signal and the received signal). When the carrier frequency of the transmission signal is continuously changed as a function of time as shown in FIG. 4, the carrier frequency of the signal reflected and then received from the RF tag 1 or the obstacle 2 varies as indicated by a broken line in FIG. 4. The beat frequency that is obtained by subtracting the frequency of the received signal from the frequency of the transmission signal varies as shown in FIG. 4.

The round trip distance of the radio wave between the contactless reader/writer 3 and the RF tag 1 or the obstacle 2 is denoted by Z. The Doppler frequency generated by the motion of the RF tag 1 is denoted by fd. The speed of the radio wave is denoted by C, the modulation time by T,, and the frequency shift width by Δf. The beat frequency when the carrier frequency is increasing is denoted by fup, while the beat frequency when the carrier frequency is decreasing is denoted by fdown. Then, the beat frequencies are obtained as shown in (Equation 40) and (Equation 41).

$$\begin{matrix}{f}_{up} = \frac{Δ f}{Tc} Z - {f}_{d} & [ Equation 40 ] \\ {f}_{down} = - \frac{Δ f}{Tc} Z - {f}_{d} & [ Equation 41 ]\end{matrix}$$

When the difference of the beat frequencies (Equation 40) and (Equation 41) is calculated, the second terms of (Equation 40) and (Equation 41) cancel out. Thus, the round trip distance Z of the radio wave between the contactless reader/writer 3 and the RF tag 1 or the obstacles 2 is obtained as shown in (Equation 42).

$$Z = \frac{Tc ( {f}_{up} - {f}_{down} )}{2 Δ f} \qquad [ Equation 42 ]$$

When the sum of the beat frequencies (Equation 40) and (Equation 41) is calculated, the first terms of (Equation 40) and (Equation 41) cancel out. Thus, according to (Equation 22), the relative velocity V of the RF tag 1 and the contactless reader/writer 3 is obtained as shown in (Equation 43).

$$V = - \frac{λ ( {f}_{up} + {f}_{down} )}{4} \qquad [ Equation 43 ]$$

That is, when the carrier frequency of the transmission signal is continuously changed as a function of time, the distance to the RF tag 1 and the obstacle 2 from the contactless reader/writer 3 and the traveling speed of the RF tag 1 or the obstacle 2 can be calculated.

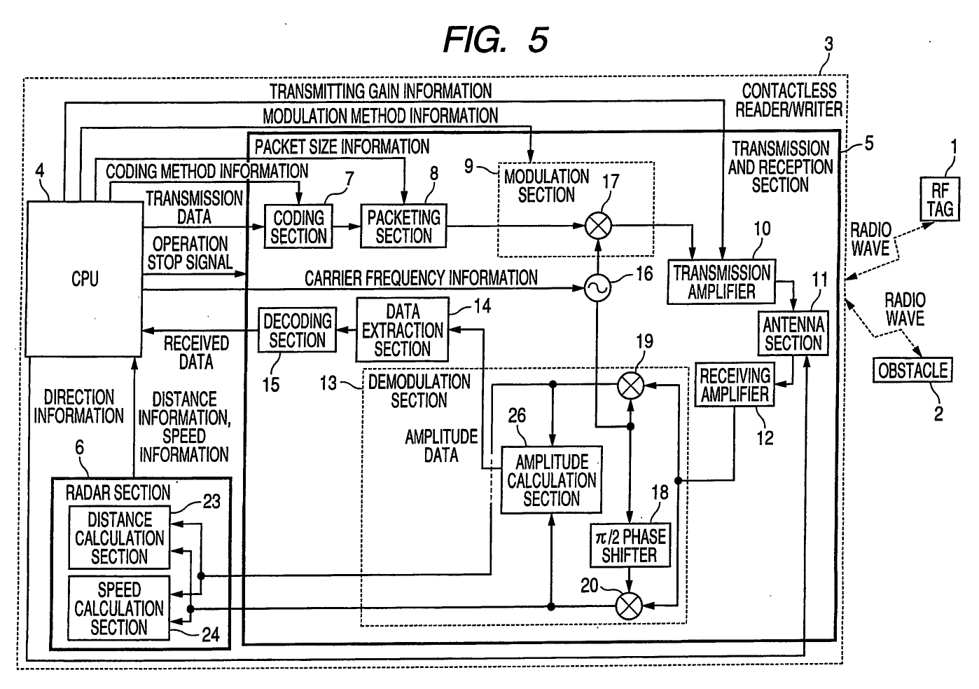

The differences in the present embodiment from Embodiment 1 are described below with reference to FIG. 5.

The amplitude calculation section 26 calculates the amplitudes of the baseband signals on the basis of the in-phase component and the quadrature component of the baseband signals outputted from the mixer 19 and the mixer 20, and then outputs the amplitude data to the data extraction section 14.

The operation is described below for the communication system for RF tags having this configuration.

The transmission data outputted from the CPU 4 for the transmission to the RF tag 1 is coded by the coding section 7. Then, the coded data is converted into a packet by the packeting section 8, and then processed by pass band modulation in the modulation section 9. The signal E processed by pass band modulation in the modulation section 9 is expressed by (Equation 44). Here, its amplitude is denoted by AS, while the carrier frequency is denoted by fct.
E=Aₛ cos(2πf_{ct}t) [Equation 44]

Carrier frequency information is outputted from the CPU 4 to the oscillator 16 so that the carrier frequency fct is continuously changed as a function of time. The employed modulation method is amplitude modulation. Signal information to be transmitted to the RF tag 1 is contained in AS. Phase modulation and frequency modulation cannot be used because the carrier frequency varies as a function of time.

The signal is amplified by the transmission amplifier 10, and then radiated through the antenna section 11. The signal radiated from the antenna section 11 is reflected by the RF tag 1 or the obstacle 2. The reflected signal is received by the antenna section 11. Then, the signals received by the antenna section 11 are amplified by the receiving amplifier 12.

Described below first is the case that the signal is reflected by the RF tag 1.

The round trip distance of the radio wave between the contactless reader/writer 3 and the RF tag 1 is denoted by Z.

The Doppler frequency generated by the motion of the RF tag 1 is denoted by fd. The amplitude of the signal E modulated by the RF tag 1 is denoted by AS1′ , the propagation constant by k, and the carrier frequency by fcr. Then, the received signal reflected by the RF tag 1 is expressed by (Equation 45). The modulation method in the RF tag 1 is assumed to be amplitude modulation.
E=Aₛ cos(2π(f_{cr}−f_{ct}±f_{d})t−kz) [Equation 45]

The received signal amplified by the receiving amplifier 12 is processed by orthogonal detection in the demodulation section 13, and thereby frequency-converted into the base band. This obtained signal is expressed by (Equation 46) and (Equation 47). Here, the in-phase component of E is denoted by EI, while the quadrature component is denoted by EQ. These baseband signals are outputted to the amplitude calculation section 26 and to the distance calculation section 23 and the speed calculation section 24 provided in the radar section 6.
E_{I}=Aₛ ′ cos(2π(f_{cr}−f_{ct}±f_{d})t−kz) [Equation 46]
E_{Q}=Aₛ ′ sin(2π(f_{cr}−f_{ct}±f_{d})t−kz) [Equation 47]

The amplitude calculation section 26 converts the baseband signals into polar coordinates, and thereby calculates amplitude data AS′ . The amplitude calculation section 26 outputs the calculated amplitude data to the data extraction section 14. The data extraction section 14 performs data extraction by using the inputted amplitude data AS′ as the amplitude data containing the identification information and the like of the RF tag 1, and then outputs the data to the decoding section 15.

The decoding section 15 decodes the inputted data, and then outputs the decoded data as the received data to the CPU 4.

The distance calculation section 23 and the speed calculation section 24 in the radar section 6 extract the frequency component (Equation 48) on the basis of the baseband signals (Equation 46) and (Equation 47) by using fast Fourier transform or the like.
f_{cr}−f_{ct}±f_{d} [Equation 48]

The (Equation 48) represents the beat frequency obtained by subtracting the frequency of the transmission signal from the frequency of the received signal. Thus, multiplying this by −1, the beat frequencies fup and fdown are obtained.

Using the beat frequencies fup and fdown, the distance calculation section 23 calculates the distance Z according to (Equation 42).

Using the beat frequencies fup and fdown and the speed of the contactless reader/writer 3 itself, the speed calculation section 24 calculates the speed of the RF tag 1 according to (Equation 43).

Next, in the case that the transmission signal radiated from the contactless reader/writer 3 is reflected by the obstacle 2, the (Equation 45) expressing the case that the signal is reflected by the RF tag 1 is modified into (Equation 49).
E=Aₛ cos(2 π(f_{cr}±f_{d})t−kz) [Equation 49]

The employed calculation procedure for the distance, the speed, and the received data is similar to that of the case of the RF tag 1.

Whether the reflected signal received in the contactless reader/writer 3 is caused by the RF tag 1 or by the obstacle 2 is determined by checking in the CPU 4 whether the received data inputted to the CPU 4 is the same as the transmitted data or not. When these data pieces are the same, the obstacle 2 is determined as the source. That is, when the received signal has not been modulated by the RF tag 1, the reflected signal is determined as not from the RF tag 1 but from the obstacle 2.

As described above, in the case that the modulation method in the RF tag 1 supports amplitude modulation as described above, when the distance calculation section 23 and the speed calculation section 24 are merely added to a general contactless reader/writer, the contactless reader/writer 3 capable of calculating the distance to the RF tag 1 or the obstacle 2 and the traveling speed of the RF tag 1 or the obstacle 2 is realized without the necessity of newly providing a special antenna or a special transmission and reception circuit for a dedicated radar for detecting the RF tag 1 and the like.

Further, the signal used here is that employed in the communication between the RF tag 1 and the contactless reader/writer 3. Thus, the distance to the RF tag 1 or the obstacle 2 and the traveling speed of the RF tag 1 or the obstacle 2 can be calculated during the normal communication with the RF tag 1.

(Embodiment 5)

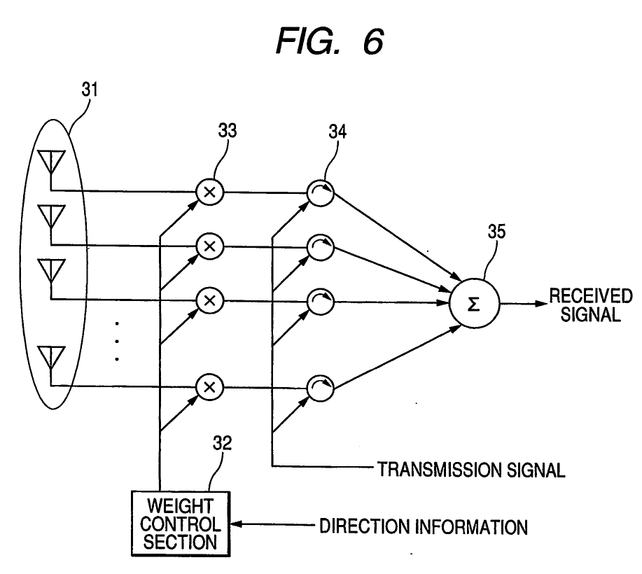

In the description of the present embodiment, like parts to Embodiments 1 through 4 are designated by like numerals, and hence detailed description is omitted. The differences from Embodiment 1 are that the antenna section 11 is an array antenna -capable of scanning the radiated wave (main beam) electronically and that the CPU 4 outputs direction information to the antenna section 11. This realizes the detection of the direction of a detected object. The array antenna indicates an arrangement of a plurality of antenna elements in which the amplitude and the phase of excitation of each element are independently controllable. An example of the array antenna is shown in FIG. 6.

In FIG. 6, numeral 31 indicates an array antenna in which a plurality of antenna elements each composed of a conductor are arranged. Numeral 32 indicates a weight control section for performing weight assignment to the signal of each antenna element on the basis of the direction information specified by the CPU 4. Numeral 33 indicates a multiplier for multiplying the signal of each antenna element by a weight component outputted from the weight control section 32. Numeral 34 indicates a circulator for outputting the transmission signal to the antenna element and for outputting the input signal from the antenna to an adder 35. Numeral 35 indicates the adder for adding the input signals from the antenna elements and then outputting the sum as the received signal to the receiving amplifier 12.

The operation is described below for the array antenna having this configuration.

On the basis of the direction where measurement is desired for the distance and the speed, the CPU 4 outputs direction information to the antenna section 11. In order that the radiated wave should direct toward the direction specified by the CPU 4, the multiplier 33 multiplies the amplitude and the phase of the signal flowing through each antenna element by each weight component outputted from the weight control section 32 so as to weigh teach antenna element. As a result, the radiated wave is scanned electronically. Employable methods of weighting include: the directivity of the antenna elements are combined so that a radiated wave in a predetermined direction is formed by the entirety of the array antenna 31; and antennas each having-a sharp directivity are switched.

Then, when scanning is performed with changing the radiated direction of the radiated wave as described above, the RF tag 1, the obstacle 2, and the like present within the scan area can be detected.

As described above, when the antenna section 11 employs the array antenna 31 capable of scanning the radiated wave electronically, the direction of the RF tag 1 or the obstacle 2 can be calculated in addition to the distance and the speed. Thus, the position can be specified on the basis of the distance and the direction.

(Embodiment 6)

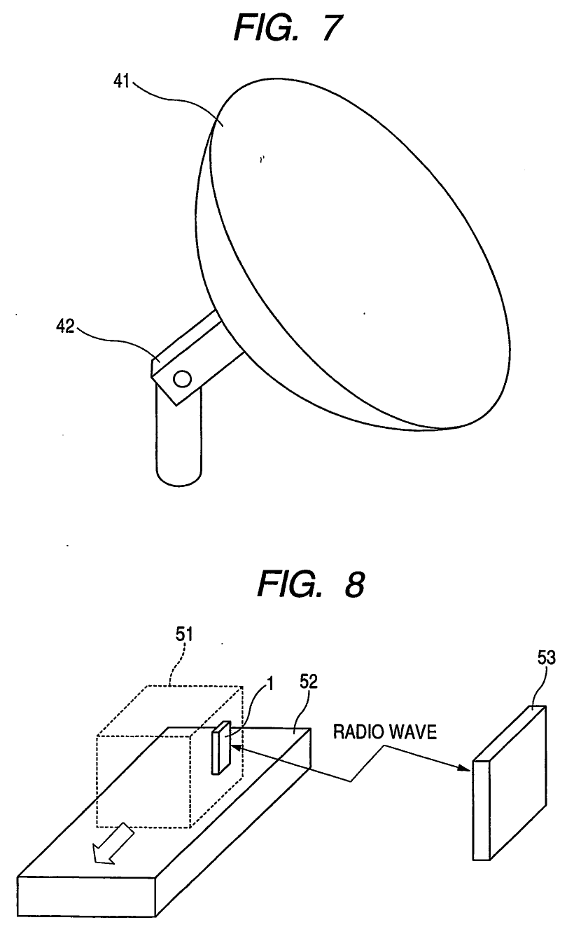

In the description of the present embodiment, like parts to Embodiments 1 through 4 are designated by like numerals, and hence detailed description is omitted. The differences from Embodiment 1 are that the antenna section 11 is a driven type antenna the transmission direction of which is variable and that the CPU 4 outputs direction information to the antenna section 11. This realizes the detection of the direction of a detected object. An example of the driven type antenna is shown in FIG. 7.

In FIG. 7, numeral 41 indicates an antenna element composed of a conductor, and has directivity. Numeral 42 indicates an antenna driving section for moving the antenna element 41 on the basis of the direction information specified by the CPU 4, and thereby controlling the direction and the elevation angle of the radiated wave mechanically.

The operation is described below for the driven type antenna having this configuration.

On the basis of the direction where measurement is desired for the distance and the speed, the CPU 4 outputs direction information to the antenna driving section 42. In response to the signal from the CPU 4, the antenna driving section 42 moves the antenna element 41 such that the direction of the radiated wave should direct toward the direction specified by the CPU 4. As a result, the radiated wave is scanned mechanically.

When scan is performed by changing the radiated direction of the radiated wave as described above, the RF tag1, the obstacle 2, and the like present within the scan area are detected.

As described above, when the antenna section 11 employs the antenna element 41 and the antenna driving section 42 for moving the antenna element 41, the radiated wave can be scanned mechanically. As a result, the direction of the RF tag 1 or the obstacle 2 can be calculated in addition to the distance and the speed. Thus, the position can be specified on the basis of the distance and the direction.

(Embodiment 7)

In the description of the present embodiment, like parts to Embodiments 1 through 4 are designated by like numerals, and hence detailed description is omitted. The difference from Embodiments 1 through 4 is that the RF tag 1 is tracked for a predetermined time after the detection of the RF tag 1.

FIG. 8 shows the schematic configuration of the communication system for RF tags according to the present embodiment. In FIG. 8, numeral 51 indicates a package on which the RF tag 1 is stuck. Numeral 52 indicates a conveyor belt for moving the package 51. Numeral 53 indicates a contactless reader/writer capable of changing the radiated direction of the radio wave as shown in Embodiment 5 or 6.

The operation is described below for the communication system for RF tags having this configuration.

When the contactless reader/writer 53 detects the RF tag 1, until entire communication to be performed between the RF tag 1 and the contactless reader/writer 53 is completed, the antenna section 11 is controlled such that the radiated wave always follows the direction of the traveling RF tag 1 so that the RF tag 1 is tracked by a method described below.

The method of tracking is as follows. When the position of the RF tag 1 is detected, the direction of the radiated wave of the antenna section 11 is changed at any time in such a manner that the angle difference between the direction of the RF tag 1 and the radiated direction of the radiated wave radiated from the antenna section 11 becomes approximately zero, that is, in such a manner that the directions of the RF tag 1 and the radiated wave approximately agree with each other. Then, the RF tag 1 is tracked. Further, when the speed information of the traveling RF tag 1 is acquired and then the detection of the RF tag 1 is performed by changing the direction of the radiated wave, the position of the traveling RF tag 1 can be predicted. This improves the follow-up precision in the tracking of the RF tag 1.

As described above, when the direction of the antenna section 11 is changed in accordance with the motion of the detected RF tag 1 so that the radiated direction of the radio wave is controlled such that the radio wave is radiated toward the RF tag 1, the contact less reader/writer 53 can perform stable communication without break off even when the RF tag 1 is traveling.

(Embodiment 8)

In the description of the present embodiment, like parts to Embodiments 1 through 4 are designated by like numerals, and hence detailed description is omitted. The difference from Embodiment 1 is that after the distance to the RF tag 1 is calculated, the transmission output is optimized depending on the distance.

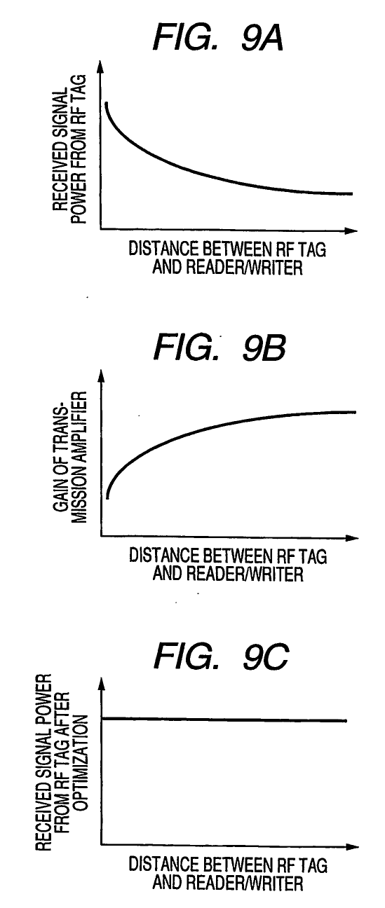

The operation of the communication system for RF tags according to the present embodiment is described below with reference to FIG. 9.

FIG. 9A shows an example of the relation between the distance of the RF tag 1 relative to the contactless reader/writer 3 and the received signal power from the RF tag 1. As shown in FIG. 9A, with increasing distance between the RF tag 1 and the contactless reader/writer 3, the received signal power decreases as it is received by the contactless reader/writer 3 from the RF tag.

On the basis of the distance between the RF tag 1 and the contactless reader/writer 3 obtained from the radar section 6, the CPU 4 estimates the received signal power from the RF tag 1 as described below, and thereby controls the gain of the transmission amplifier 10 such that a reverse characteristic to FIG. 9A is obtained as shown in FIG. 9B of the gain characteristics of the transmission amplifier as a function of the distance between the RF tag 1 and the contactless reader/writer 3. Specifically, the CPU 4 outputs transmitting gain information to the transmission amplifier 10. Then, the transmission amplifier 10 changes the gain on the basis of the transmitting gain information such as to maintain the received signal power from the RF tag 1 to be constant as shown in FIG. 9C. The estimation of the received signal power is performed as follows.

The transmission power of the contactless reader/writer 3 is denoted by Pi. The received power of the contactless reader/writer 3 is denoted by Pr. The reflection coefficient of the RF tag 1 is γ. The distance between the RF tag 1 and the contactless reader/writer 3 is d. The propagation loss at distanced is PL (d). The transmission antenna absolute gain in the contactless reader/writer 3 is Grw_t. The receiving antenna absolute gain in the contactless reader/writer 3 is Grw_r. The transmission antenna absolute gain in the RF tag 1 is Gtag_t. The receiving antenna absolute gain in the RF tag 1 is Gtag_r. Then, the received power of the contactless reader/writer 3 is expressed by (Equation 50).

Pᵣ=(G_{rw}_{_{—}}ₜ·G_{tag}_{_{—}}ᵣ·Pᵢ/PL(d))×γ×(G_{tag}_{_{—}}ₜ·G_{rw}_{_{—}}ᵣ/PL(d)) [Equation 50]

The value of the propagation loss may be estimated by any method. Employable methods include: the relation between the propagation loss and distance of the RF tag 1 relative to the contactless reader/writer 3 is measured in the operating environment in advance so that the data is referenced; a theoretical formula (Equation 51) for the propagation loss in free space is used that calculates a theoretical value of the propagation loss in the case that the radio wave is propagated in ideal space free from obstacles such as a reflecting object that affects the radio wave propagation; and an estimation formula represented by the Okumura model is used that estimates empirically the loss value which varies depending on the environment such as the vicinity of a building, the plain, and the like.

When a part of constants in the theoretical formula for the propagation loss in free space is changed, the loss value can be estimated even for an environment which is not an ideal space such as the vicinity of a building, the plain, and the like. Then, the received power is estimated using (Equation 50).

$$PL ( d ) = {( \frac{4 π d}{λ} )}^{2} \qquad [ Equation 51 ]$$

d: Propagated distance [m]

λ: Wavelength [m]

As described above, when depending on the communication distance to the RF tag 1, the transmission output of the contactless reader/writer 3 is optimized, stable communication is achieved regardless of the distance between the RF tag 1 and the contactless reader/writer 3.

In the related art contactless reader/writer, when the transmission output is set at a rather high value in order to extend the communication achievable distance, a problem has arisen that the received signal power can saturate at short distances so that the communication is prevented. However, in the contactless reader/writer 3 according to the present embodiment, the transmission output is adjusted depending on the communication distance to the RF tag 1, and hence this problem is resolvable.

(Embodiment 9)

In the description of the present embodiment, like parts to Embodiments 1 through 6 are designated by like numerals, and hence detailed description is omitted. The difference from these embodiments is that when a reflecting object is present in the surroundings between the RF tag 1 and the contactless reader/writer 3, the transmission output is optimized depending on the positions of the RF tag 1 and the obstacle 2.

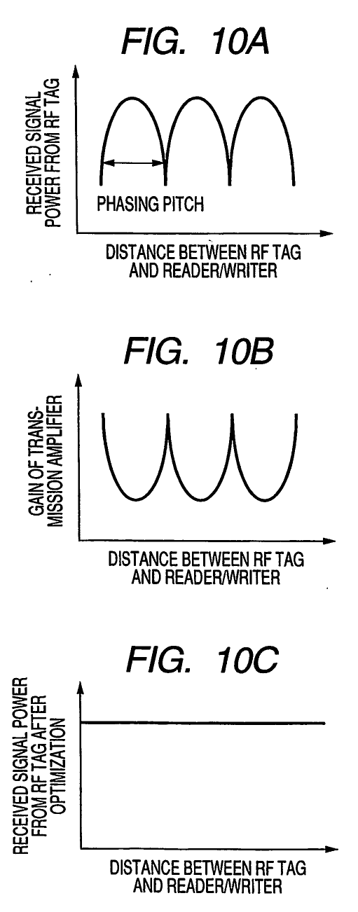

FIG. 10A is a diagram showing an example of the relation between the distance of an RF tag 1 relative to a contactless reader/writer 3 and the received signal power from the RF tag 1. When a reflecting object serving as the obstacle 2 is present in the surroundings between the RF tag 1 and the contactless reader/writer 3, phasing occurs as shown in FIG. 10A. The phasing pitch varies depending on the arrangement of the obstacle 2. However, a proportional relation holds with respect to the wavelength. For example, when the reflecting object is present in the transmission direction of the radio wave, the phasing pitch becomes 0.5 wavelength.

On the basis of the positions of the RF tag 1 and the obstacle 2 obtained from the calculation results of the radar section 6 and the like, the CPU 4 estimates the received signal power from the RF tag 1 by means of an electromagnetic field simulation described below, and thereby controls the gain of the transmission amplifier 10 such that a reverse characteristic to FIG. 10A is obtained as shown in FIG. 10B. As such, the received signal power from the RF tag 1 is maintained at constant as shown in FIG. 10C. The estimation of the received signal power is performed as follows.

The method of electromagnetic field simulation used in the estimation of the received signal power may be any one such as the finite element method, the FDTD method, the moment method, and the ray trace method.

As for the information such as the reflection coefficient of the obstacle 2, when the operating environment is known in advance, the materials information of the obstacle 2 used in the space is adopted. Otherwise, a basic model of a building where the communication system for RF tags is used at the highest probability is determined so that the materials information of the obstacle 2 used there is adopted.

When the computing capability of the CPU 4 in the contactless reader/writer 3 does not satisfy the computing capability required for the electromagnetic field simulation, a computer may be connected to the contactless reader/writer 3 so that the received signal power may be estimated in the computer.

As described above, when the transmission output is optimized depending on the positions of the RF tag 1 and the obstacle 2, stable communication is achieved even in a communication environment having phasing.

(Embodiment 10)

In the description of the present embodiment, like parts to Embodiment 9 are designated by like numerals, and hence detailed description is omitted. The difference from Embodiment 9 is that the wavelength of the carrier wave of the transmission signal is optimized depending on the positions of the RF tag 1 and the obstacle 2. Specifically, the CPU 4 outputs carrier frequency information to the oscillator 16 so that the oscillator 16 outputs to the modulation section 9 a carrier wave of the frequency specified by the CPU 4.

The operation is described below for the communication system for RF tags having this configuration.

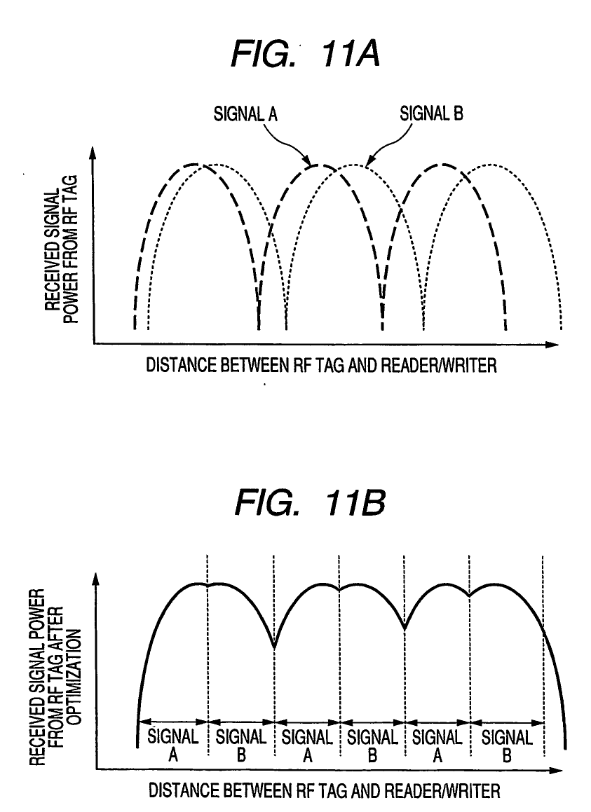

As shown in Embodiment 9, when a reflecting object serving as the obstacle 2 is present in the surroundings between the RF tag 1 and the contactless reader/writer.3, phasing occurs, and the phasing pitch is proportional to the wavelength. FIG. 11A is a diagram showing an example of the relation between the distance of an RF tag 1 relative to a contactless reader/writer 3 and the received signal power from the RF tag 1. Signals A and B indicate two signals each modulated with a carrier wave having a mutually different wavelength.

On the basis of the positions of the RF tag 1 and the obstacle 2 obtained from the calculation results of the radar section 6 and the like, the CPU 4 estimates the received signal power from the RF tag 1 in an electromagnetic field simulation, and thereby switches the wavelength of the carrier wave into one causing the higher received signal power, depending on the positions of the RF tag 1 and the obstacle 2. That is, in the present embodiment, the more suitable one in the signals A and B is selected and used. Then, the characteristics as shown in FIG. 11B are obtained so that a rapid reduction in the received signal power from the RF tag 1 is avoided. The estimation of the received signal power is performed by the same method as in Embodiment 9.

As described above, when the wavelength of the carrier wave is optimized depending on the positions of the RF tag 1 and the obstacle 2, degradation in the receiving performance caused by a rapid reduction in the received power is avoided even in a communication environment having phasing.

(Embodiment 11)

In the description of the present embodiment, like parts to. Embodiment 9 or 10 are designated by like numerals, and hence detailed description is omitted. The difference from Embodiment 9 or 10 is that the modulation method for the transmission signal is optimized depending on the positions of the RF tag 1 and the obstacle 2. Specifically, the CPU 4 outputs modulation method information to the modulation section 9 so that the modulation section 9 performs modulation by the modulation method specified by the CPU 4.

The operation is described below for the communication system for RF tags having this configuration.

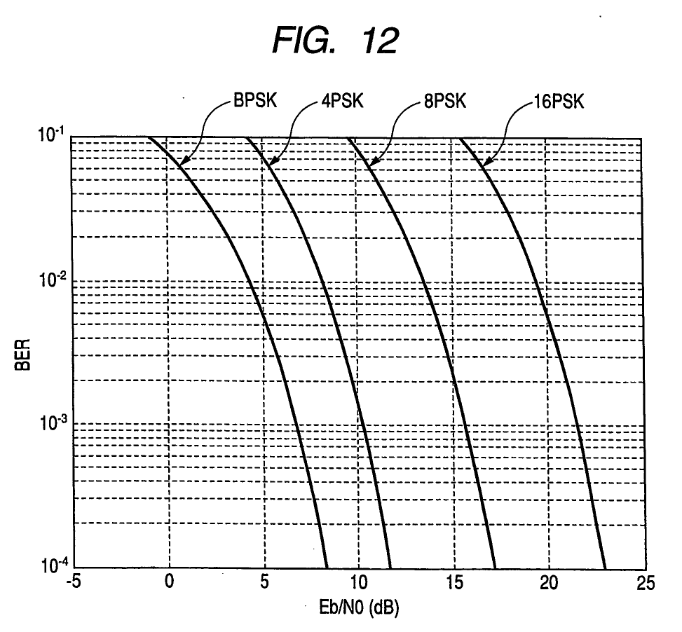

Each kind of modulation method has advantages and disadvantages, and hence the optimum modulation method varies depending on the communication environment. As an example, FIG. 12 shows the bit error rate in multiphase PSK. By increasing multiphase, like two-phase, four-phase, and eight-phase, the transmission speed improves. Nevertheless, the bit error rate degrades.

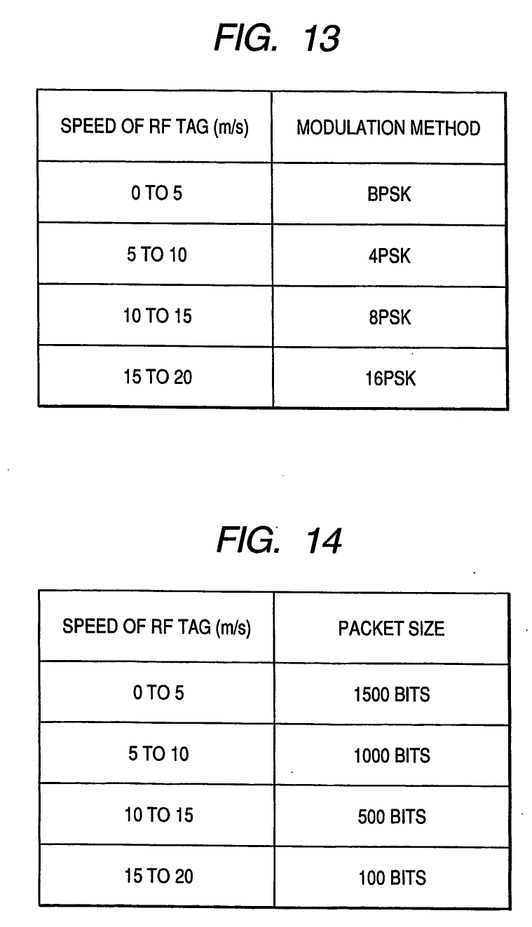

On the basis of the position and speed information of the RF tag 1 or the obstacle 2 obtained from the calculation results of the radar section 6 and the like, the CPU 4 recognizes the communication environment, and thereby changes the method of the modulation performed by the modulation section 9. Further, the detection method of the demodulation section 13 is also changed in accordance with the change of the modulation method. Specifically, in the case of a poor communication environment such as that the traveling speed of the RF tag 1 is high and hence the bit error rate characteristic degrades and that the communication distance between the RF tag 1 and the contactless reader/writer 3 is long and hence the received signal power decreases so that the bit error rate degrades, the modulation method is changed into one having a good bit error rate characteristic. That is, the transmission speed is less prioritized, while improvement in the bit error rate is prioritized. In the case of a good communication environment, a modulation method is adopted that has a high transmission speed, that is, improvement is prioritized in the transmission speed. FIG. 13 shows an example of a correspondence table for the speed of the RF tag 1 and the modulation method. Such a correspondence table may be prepared in advance on the basis of experiments or the like so that the CPU 4 may determine the modulation method on the basis of this table.

As described above, the communication environment is recognized on the basis of the position and speed information of the RF tag 1 or the obstacle 2, and then the modulation method is optimized. This realizes optimization of the transmission speed and improvement in the bit error rate.

(Embodiment 12)

In the description of the present embodiment, like parts to Embodiments 9 through 11 are designated by like numerals, and hence detailed description is omitted. The difference from Embodiments 9 through 11 is that the packet size of the transmission signal is optimized depending on the positions of the RF tag 1 and the obstacle 2. Specifically, the CPU 4 outputs packet size information to the packeting section 8 so that the packeting section 8 performs modulation using the packet size specified by the CPU 4.

The operation is described below for the communication system for RF tags having this configuration.

When the total bit number of the packet is denoted by n, the packet error rate PER is expressed by the following (Equation 52) using the bit error rate BER.
PER=1−(1−BER)ⁿ [Equation 52]

That is, when the total bit number of the packet increases, the throughput improves, while the packet error rate increases. On the contrary, when the total bit number of the packet decreases, the throughput decreases, while the packet error rate improves.

On the basis of the position and speed information of the RF tag 1 or the obstacle 2 obtained from the calculation results of the radar section 6 and the like, the CPU 4 recognizes the communication environment, and thereby changes the packet size in the packeting process performed in the packeting section 8. Specifically, in the case of a poor communication environment such as that the traveling speed of the RF tag 1 is high and hence the bit error rate characteristic degrades and that the communication distance between the RF tag 1 and the contactless reader/writer 3 is long and hence the received signal power decreases so that the bit error rate degrades, the packet size in the packeting process is reduced so that the throughput is less prioritized, while improvement in the packet error rate is prioritized. In the case of a good communication environment, the packet size in the packeting process is increased so that improvement is prioritized in the throughput.

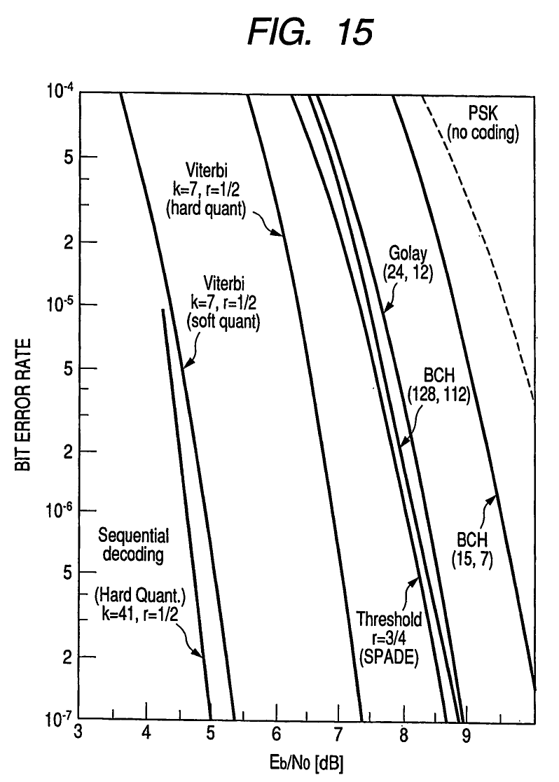

FIG. 14 shows an example of a correspondence table for the traveling speed of the RF tag 1 and the packet size. Such a correspondence table may be prepared in advance on the basis of experiments or the like so that the CPU 4 may determine the packet size on the basis of this table.

As described above, the communication environment is recognized on the basis of the position and speed information of the RF tag 1 or the obstacle 2, and then the packet size in the packeting process is optimized. This realizes optimization of the transmission speed and improvement in the packet error rate.

(Embodiment 13)

In the description of the present embodiment, like parts to Embodiments 9 through 12 are designated by like numerals, and hence detailed description is omitted. The difference from Embodiments 9 through 12 is that the coding method is optimized depending on the positions of the RF tag 1 and the obstacle 2. Specifically, the CPU 4 outputs coding method information to the coding section 7 so that the coding section 7 performs coding by using the coding method specified by the CPU 4.

The operation is described below for the communication system for RF tags having this configuration.

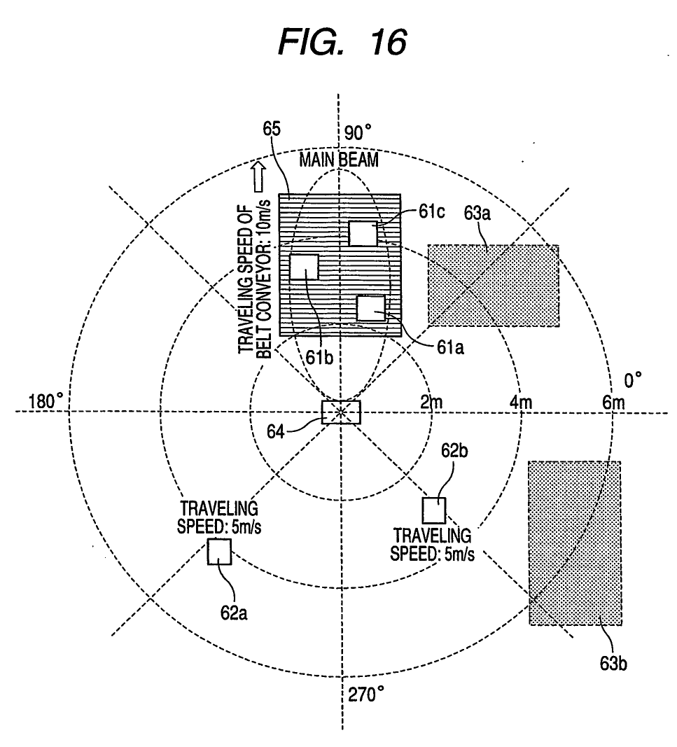

FIG. 15 shows the bit error rate in PSK and the bit error rate when error-correction code coding is performed on PSK. As seen from FIG. 15, when the error-correction code coding is employed, the bit error rate is improved. Further, the coding gain varies depending on the coding method. In general, a coding method having a higher coding gain requires an increasing amount of calculation, and hence causes a reduction in the processing speed, an increase in the power consumption, and the like. For example, in comparison with block coding such as the BCH (Bose Chaudhuri Hocquenghem) coding, the Viterbi decoding requires a folding operation and hence causes an increase in calculation complexity.

On the basis of the position and speed information of the RF tag 1 or the obstacle 2 obtained from the calculation results of the radar section 6 and the like, the CPU 4 recognizes the communication environment, and thereby changes the coding method performed in the coding section 7. Specifically, in the case of a poor communication environment such as that the traveling speed of the RF tag 1 is high and hence the bit error rate characteristic degrades and that the communication distance between the RF tag 1 and the contactless reader/writer 3 is long and hence the received signal power decreases so that the bit error rate degrades, a coding method having a high coding gain is adopted so that a lower processing speed and a higher power consumption are accepted, while improvement in the bit error rate is prioritized. For example, the method is changed from BCH into Viterbi. In the case of a good communication environment, a coding method having a lower coding gain is adopted so that improvement is prioritized in the processing speed and the power consumption.

As described above, the communication environment is recognized on the basis of the position and speed information of the RF tag 1 or the obstacle 2, and then the coding method is optimized. This realizes optimization of the processing speed and the power consumption and improvement in the bit error rate.

(Embodiment 14)

In the description of the present embodiment, like parts to Embodiment 5 or 6 are designated by like numerals, and hence detailed description is omitted. The difference from Embodiment 5 or 6 is that a contactless reader/writer 64 detects the positions of a plurality of RF tags and obstacles within the communication area of the contactless reader/writer 64, and then communicates with RF tags present within a desired area.

In FIG. 16, numerals 61a, 61b, and 61c indicate packages placed on a conveyor belt 65 and moved by this conveyor belt 65. An RF tag is stuck to each package. Numerals 62a and 62b indicate packages to which an RF tag is stuck. Numerals 63a and 63b indicate obstacles present around the communication system for RF tags. For example, the obstacles are: walls of the building where the communication system for RF tags is used; and equipment present in the building. Numeral 64 indicates the contactless reader/writer for performing wireless communication with the RF tags similarly to the contactless reader/writer shown in Embodiments 5 and 6. Numeral 65 indicates a conveyor belt for moving the packages 61a, 61b, and 61c. In FIG. 16, although the traveling speeds are indicated for the packages 62a and 62b and the conveyor belt 65, the present embodiment is described for the case that these packages are not traveling.

The operation is described below for the communication system for RF tags having this configuration.

As an example, described below is the case that communication is to be performed slowly with the three packages 61a, 61b, and 61c placed on the conveyor belt 65. First, according to a method described in the embodiments described above, the contactless reader/writer 64 detects the position information of all the RF tags present around the contactless reader/writer 64. The detection area of the contactless reader/writer 64 depends on the communication achievable distance of the contactless reader/writer 64.

Then, the CPU 4 outputs to the antenna section 11 the direction information of the packages 61a, 61b, and 61c detected by the radar section 6 and present in the area where the conveyor belt 65 is present. Then, the antenna section 11 directs the radiated wave toward that direction. As such, when the radiated wave is directed to the area where the packages 61a, 61b, and 61c are present, communication is not performed with the package 62 outside the area. This configuration is advantageous, for example, in the case that information is to be written solely into RF tags present within a predetermined area.

As such, communication with RF tags can be controlled depending on the area. This prevents erroneous communication with RF tags in an area where communication is not desired.

Further, the position information is detected for all the RF tags present around the contactless reader/writer 64. Then, the information of RF tags present within a predetermined area is solely validated. An example of a validity process is that when the identification information of RF tags is to be acquired and processed, the information of the other (not valid) RF tags is set as invalid. A specific example of an invalid process is that the information is discarded so that the information of the desired RF tags is solely obtained. Then, for example, the information of the necessary and desired RF tags may solely be transmitted to an external device or the like.

(Embodiment 15)

In the description of the present embodiment, like parts to Embodiment 14 are designated by like numerals, and hence detailed description is omitted. The difference from Embodiment 14 is that the contactless reader/writer 64 detects the positions of a plurality of RF tags and obstacles within the communication area of the contactless reader/writer 64, and then stops the communication by the contactless reader/writer 64 when no RF tag is present within a desired communication area.

As an example, described below is the case that communication is to be performed solely with the three packages 61a, 61b, and 61c that are being moved by the conveyor belt 65. First, the radar section 6 inside the contactless reader/writer 64 detects the position information of all the RF tags present around the contactless reader/writer 64. The detection area of the contactless reader/writer 64 depends on the communication achievable distance of the contactless reader/writer 64.

Then, on the basis of the detection result detected by the radar section 6, when no RF tag is detected in the area where the conveyor belt 65 is present, the CPU 4 outputs an operation stop signal to the transmission and reception section 5 so as to stop the transmission and reception operation performed in the transmission and reception section 5. This reduces the power consumption.

As described above, when the communication by the contactless reader/writer 64 is stopped no RF tag is present in the area where the communication is desired. This improves the power consumption.

(Embodiment 16)

In the description of the present embodiment, like parts to Embodiments 14 and 15 are designated by like numerals, and hence detailed description is omitted. The difference from Embodiments 14 and 15 is that the contactless reader/writer 64 detects the positions and the speeds of a plurality of RF tags present within the communication area of the contactless reader/writer 64, and then communicates solely with RF tags traveling at a desired traveling speed.

In FIG. 16, the packages 61a, 61b, and 61c are placed on the conveyor belt 65 and traveling at the traveling speed 10 m/s of the conveyor belt 65. The packages 62a and 62b are traveling at a speed of 5 m/s and at a speed of 5 m/s, respectively.

The operation is described below for the communication system for RF tags having this configuration.

As an example, described below is the case that communication is desired solely with RF tags on packages traveling at a speed of 10 m/s. First, the radar section 6 in the contactless reader/writer 64 detects the speed information of all the RF tags present around the contactless reader/writer 64. The detection area depends on the communication achievable distance of the contactless reader/writer 64.

In this case, the traveling speed of the packages 61a, 61b, and 61c placed on the conveyor belt 65 is 10 m/s. Thus, the CPU 4 outputs the direction information of the packages 61a, 61b, and 61c to the antenna section 11 so that the antenna section 11 directs the radiated wave toward that direction. As such, when the radiated wave is directed to the area where the packages 61a, 61b, and 61c are present, communication is not performed with packages such as 62a and 62b outside the area. This configuration is advantageous, for example, in the case that information is to be written solely into RF tags traveling at a predetermined speed.

As such, communication with RF tags can be controlled depending on the speed of the RF tags. This prevents erroneous communication with RF tags having a speed outside a predetermined speed range.

Further, the position information is detected for all the RF tags present around the contactless reader/writer 64. Then, the information of RF tags traveling at a predetermined speed is solely validated. An example of a validity process is that when the identification information of RF tags is to be acquired and processed, the information of the other (not valid) RF tags is set as invalid. A specific example of an invalid process is that the information is discarded so that the information of the desired RF tags is solely obtained. Then, for example, the information of the necessary and desired RF tags may solely be transmitted to an external device or the like.

(Embodiment 17)

In the description of the present embodiment, like parts to Embodiment 16 are designated by like numerals, and hence detailed description is omitted. The difference from Embodiment 16 is that the contactless reader/writer 64 detects the positions and the speeds of a plurality of RF tags present within the communication area of the contactless reader/writer 64, and then stops the communication by the contactless reader/writer 64 when no RF tag is traveling at a desired traveling speed.

In FIG. 16, the packages 61a, 61b, and 61c are traveling at the traveling speed 10 m/s of the conveyor belt 65, while the packages 62a and 62b are traveling at a speed of 5 m/s and at a speed of 5 m/s, respectively.

The operation is described below for the communication system for RF tags having this configuration.

As an example, described below is the case that communication is desired solely with RF tags on packages traveling at a speed of 20 m/s. First, the radar section 6 in the contactless reader/writer 64 detects the speed information of all the RF tags present around the contactless reader/writer 64. The detection area of the contactless reader/writer 64 depends on the communication achievable distance of the contactless reader/writer 64.

When no RF tag traveling at a traveling speed of 20 m/s is detected by the radar section 6, the CPU 4 outputs an operation stop signal to the transmission and reception section 5 so that the transmission and reception section 5 stops the transmission and reception operation in response to the signal. This reduces the power consumption in the contactless reader/writer 64.

In the embodiment described here, communication is stopped when no RF tag is traveling within a predetermined speed range. This improves the power consumption.

(Embodiment 18)

In the description of the present embodiment, like parts to Embodiment 14 or 16 are designated by like numerals, and hence detailed description is omitted. The difference from Embodiment 14 or 16 is that the contactless reader/writer 64 detects the positions and the speeds of a plurality of RF tags present within the communication area of the contactless reader/writer 64, and then communicates solely with RF tags present within a desired area and traveling at a desired traveling speed.

In FIG. 16, the packages 61a, 61b, and 61c are traveling at the traveling speed 10 m/s of the conveyor belt 65, while the packages 62aand 62b are traveling at a speed of 5 m/s and at a speed of 5 m/s, respectively.

The operation is described below for the communication system for RF tags having this configuration.

As an example, described below is the case that the desired area is assumed to be on top of the conveyor belt 65 and that communication is to be performed solely with RF tags on packages traveling at a speed of 10 m/s. First, the radar section 6 in the contactless reader/writer 64 detects the position and speed information of all the RF tags present around the contactless reader/writer 64. The detection area of the contactless reader/writer 64 depends on the communication achievable distance of the contactless reader/writer 64.

The packages 61a, 61b, and 61c are placed on the conveyor belt 65, and traveling at a speed of 10 m/s. Thus, the CPU 4 outputs direction information of the packages 61a, 61b, and 61c to the antenna section 11 so that the antenna section 11 directs the radiated wave toward that direction. As such, when the radiated wave is directed to the area where the packages 61a, 61b, and 61c placed on the conveyor belt 65 and traveling at a speed of 10 m/s are present, communication is not performed with packages such as 62a and 62b outside the area. This configuration is advantageous, for example, in the case that information is to be written solely into RF tags having a predetermined speed and present within a predetermined area.

As such, communication with RF tags can be controlled depending on the speed and the area of the RF tags. This prevents erroneous communication with RF tags not having a predetermined speed and not present within a predetermined area.

Further, the position information is detected for all the RF tags present around the contactless reader/writer 64. Then, the information of RF tags traveling at a predetermined speed and present within a predetermined area is solely validated. An example of a validity process is that when the identification information of RF tags is to be acquired and processed, the information of the other (not valid) RF tags is set as invalid. A specific example of an invalid process is that the information is discarded so that the information of the desired RF tags is solely obtained. Then, for example, the information of the necessary and desired RF tags may solely be transmitted to an external device or the like.

As such, communication with RF tags can be controlled depending on a desired communication area and the speed of RF tags. Thus, for example, at the time of abnormality such as stoppage caused by a failure in the conveyor belt 65, communication with RF tags may be stopped. This ensures further the control of the communication with RF tags described in Embodiments 14 and 16 where the communication of the contactless reader/writer 64 is stopped depending on the situation.

(Embodiment 19)

In the description of the present embodiment, like parts to Embodiment 15 or 17 are designated by like numerals, and hence detailed description is omitted. The difference from Embodiment 15 or 17 is that the contactless reader/writer 64 detects the positions and the speeds of a plurality of RF tags present within the communication area of the contactless reader/writer 64 so that communication by the contactless reader/writer 64 is stopped when no RF tag is present within a desired area or alternatively when no RF tag is traveling at a desired traveling speed.

In FIG. 16, the packages 61a, 61b, and 61c are traveling at the traveling speed 10 m/s of the conveyor belt 65, while the packages 62a and 62b are traveling at a speed of 5 m/s and at a speed of 5 m/s, respectively.

The operation is described below for the communication system for RF tags having this configuration.

As an example, described below is the case that communication is to be performed solely with RF tags on packages present on the conveyor belt 65 and traveling at a speed of 20 m/s. First, the radar section 6 in the contactless reader/writer 64 detects the position and speed information of all the RF tags present around the contactless reader/writer 64. The detection area of the contactless reader/writer 64 depends on the communication achievable distance of the contactless reader/writer 64.

Then, when no RF tag in the area where the conveyor belt 65 is present is detected by the radar section 6 or alternatively when no RF tag traveling at a traveling speed equal to 20 m/s is detected, the CPU 4 outputs an operation stop signal to the transmission and reception section 5 so that the transmission and reception section 5 stops the transmission and reception operation. This reduces the power consumption in the contactless reader/writer 64.

As such, communication of the contactless reader/writer 64 is stopped when no RF tag is present in a desired communication area or when no RF tag is traveling within a predetermined speed range. This improves further the power consumption than in Embodiments 15 and 17.

(Embodiment 20)

In the description of the present embodiment, like parts to Embodiment 14 are designated by like numerals, and hence detailed description is omitted. The difference from Embodiment 14 is that communication is performed with determining order of communication for a plurality of RF tags to be communicated.

In FIG. 16, the packages 61a, 61b, and 61c are placed on the conveyor belt 65 and present in mutually different positions.

The operation is described below for the communication system for RF tags having this configuration.

As an example, described below is the case that communication is performed with the packages 61a, 61b, and 61c that are being moved by the conveyor belt 65.

First, the radar section 6 in the contactless reader/writer 64 detects the position information of the RF tags attached to the packages 61a, 61b, and 61c present on the conveyor belt 65. The detection area of the contactless reader/writer 64 depends on the communication achievable distance of the contactless reader/writer 64.

Then on the basis of the detected position information of the packages 61a, 61b, and 61c, the CPU 4 determines the order of performing communication indicating which RF tag should first be communicated and the like. For example, in the case that the communication is to be performed in the order starting at the package 61a that is nearest to the contactless reader/writer 64 and ending at the farthest package 61c so that the communication is to be ensured starting at the RF tag with a small distance attenuation for the radio wave, the CPU 4 first outputs to the antenna section 11 the direction information of the package 61a that is nearest to the contactless reader/writer 64. Then, the antenna section 11 directs the radiated wave toward that direction and then performs communication. When the communication with the nearest package 61a is completed, the CPU 4 outputs to the antenna section 11 the direction information of the package 61b that is the second nearest to the contactless reader/writer 64 so that the antenna section 11 directs the radiated wave toward that direction and then performs communication. After that, the same process is repeated until the communication with all the packages 61 is completed. When the communication with the second nearest package 61b is completed, the CPU 4 in the contactless reader/writer 64 outputs the direction information of the package 61c that is farthest from the antenna section 11 so that the antenna section 11 directs the radiated wave toward that direction and then performs communication.

As such, in contrast to the related art where communication has been performed in the order starting at one having established communication first among a plurality of RF tags, the order of communication can be controlled depending on the positions of the RF tags according to the present embodiment. This ensures communication.

(Embodiment 21)

In the description of the present embodiment, like parts to Embodiments 1 through 6 are designated by like numerals, and hence detailed description is omitted. The difference from Embodiments 1 through 6 is that a display unit 71 is provided for displaying the information such as the position and the speed of the RF tag 1 or the obstacle 2 calculated by the contactless reader/writer 3.

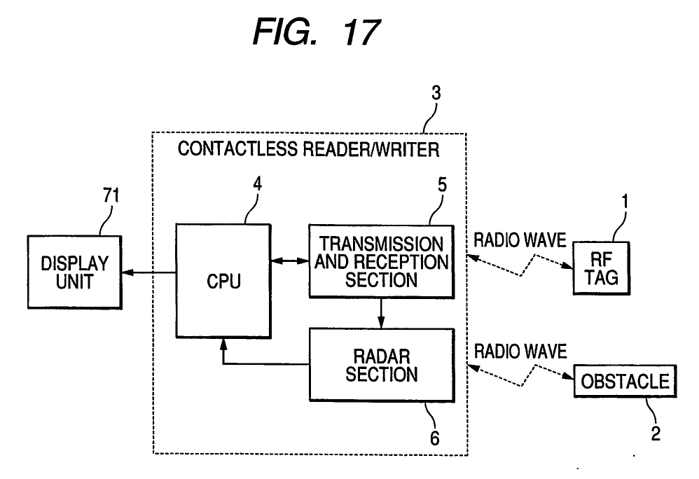

FIG. 17 is a diagram showing the schematic configuration of the communication system for RF tags of the present embodiment. In FIG. 17, numeral 71 indicates the display unit for displaying position information, speed information, and the like of the RF tag 1 or the obstacle 2 outputted from the CPU 4.

The operation is described below for the communication system for RF tags having this configuration. First, the radar section 6 in the contactless reader/writer 3 detects the position and speed information of the RF tag 1 or the obstacle 2 present around the contactless reader/writer 3.

Then, the CPU 4 outputs the position information and the speed information of the RF tag 1 or the obstacle 2 obtained by the radar section 6 to the display unit 71 connected to the contactless reader/writer. The display unit 71 displays these information pieces.

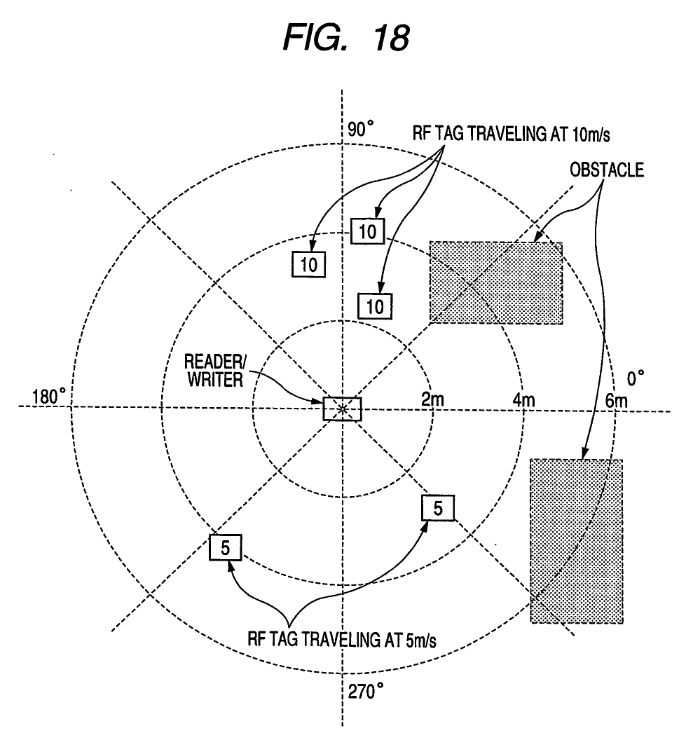

FIG. 18 shows an example of display on the display unit 71. In FIG. 18, position information is plotted on a radar chart, while the traveling speed information is given numerically.

As such, when the position information, the speed information, and the like of the RF tag 1 or the obstacle 2 is displayed on the display unit 71, an operator or the like can be notified visually so as to recognize the communication environment at a glance.

The display unit 71 may be built into the contactless reader/writer 3, or alternatively may be constructed as an external device connected to the contactless reader/writer 3.

An example of the display unit 71 is a liquid crystal display.

(Embodiment 22)

In the description of the present embodiment, like parts to Embodiments 1 through 6 are designated by like numerals, and hence detailed description is omitted. The difference from Embodiments 1 through 6 is that a speaker 72 is provided for outputting as a sound the information such as the position and the speed of the RF tag 1 or the obstacle 2 calculated by the contactless reader/writer 3.

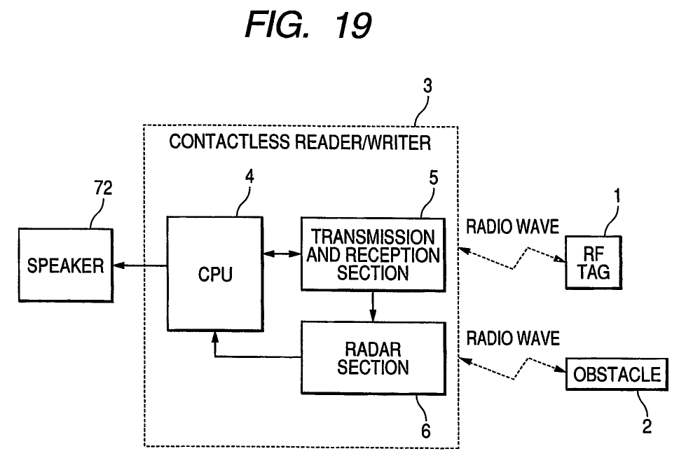

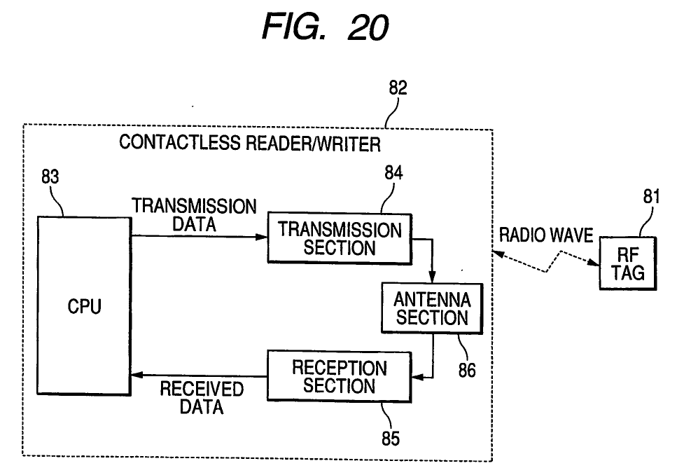

FIG. 19 is a diagram showing the schematic configuration of the communication system for RF tags of the present embodiment In FIG. 19, numeral 72 indicates a speaker for outputting as a sound the information acquired from the CPU 4.

The operation is described below for the communication system for RF tags having this configuration. First, the radar section 6 in the contactless reader/writer 3 detects the position information and the speed information of the RF tag 1 or the obstacle 2 present around the contactless reader/writer 3.

Then, the CPU 4 outputs the position information and the speed information of the RF tag 1 or the obstacle 2 obtained by the radar section 6, as a sound signal through the speaker 72 connected to the contactless reader/writer 3.

For example, when the obstacle 2 is detected in the communication area and expected to affect the communication with the RF tag 1, a beep is outputted from the speaker 72.

As such, since the position information of the RF tag 1 or the obstacle 2 is notified as sound, even when the operator leaves the site, the communication environment is notified as a sound.

The speaker 72 may be built into the contactless reader/writer 3, or alternatively may be constructed as an external device connected to the contactless reader/writer 3.

Since communication is performed with the RF tag 1 present within a predetermined area or distance as described above, for example, when the system is applied to a ticket gate machine such as that for a train, communication is performed with a ticket or the RF tag 1 having a commuter pass function which is present in a predetermined position relative to the ticket gate machine. This avoids crosstalk with the other RF tags 1. The RF tag 1 may be formed in a card shape, a coin shape, or any other shape suitable for usage.

This application is based on Japanese Patent Application No. 2004-126588 filed on Apr. 22, 2004, which is incorporated herein by reference.

### INDUSTRIAL APPLICABILITY

In a reader/writer for contactless type information storage carriers according to the invention, the system can be optimized in real time and hence is useful as a reader/writer for contactless type information storage carriers and the like.

1. A contactless reader/writer comprising:
a transmission section for transmitting a plurality of transmission signals using carrier waves of different frequencies;
a reception section for receiving a plurality of reply signals which are a response to a plurality of transmission signals transmitted by the transmission section;
a phase calculation section for calculating phase data of the reply signals on the basis of the reply signals; and
a distance calculation section for calculating a distance to an object having returned the reply signal, on the basis of the phase data from the phase calculation section.

2. The contactless reader/writer according to claim 1, wherein whether the object is an RF tag or an obstacle is determined on the basis of whether data is contained in the reply signal or not.

3. The contactless reader/writer according to claim 1, wherein the transmission section is an array antenna.

4. The contactless reader/writer according to claim 1, wherein the transmission section comprises an antenna section having directivity and an antenna driving section for moving the antenna section.

5. The contactless reader/writer according to claim 1, further comprising a control section for controlling a transmission direction of the transmission signals transmitted from the transmission section,
wherein the control section calculates the position of the object on the basis of the transmission direction and the calculation result of the distance calculation section, whereby on the basis of the calculated position of the object and the transmission direction of the transmission signals from the transmission section, the transmission direction of the transmission signals from the transmission section is directed to the position of the object.

6. The contactless reader/writer according to claim 1, further comprising a control section for performing gain control for the transmission signals transmitted from the transmission section on the basis of the calculation result of the distance calculation section.

7. The contactless reader/writer according to claim 1, further comprising a control section for controlling a transmission direction of the transmission signals transmitted from the transmission section,
wherein positions of a plurality of the objects are calculated on the basis of the transmission direction and the calculation result of the distance calculation section, whereby gain control for the transmission signals transmitted from the transmission section is performed on the basis of the positions of a plurality of the objects.

8. The contactless reader/writer according to claim 1, further comprising a control section for controlling a transmission direction of the transmission signals transmitted from the transmission section,
wherein positions of a plurality of the objects are calculated on the basis of the transmission direction and the calculation result of the distance calculation section, whereby wavelength control for the transmission signals transmitted from the transmission section is performed on the basis of the positions of a plurality of the objects.

9. The contactless reader/writer according to claim 1, further comprising a display section for displaying position information and/or speed information of an object.

10. The contactless reader/writer according to claim 1, further comprising a sound output section for outputting position information and/or speed information of an object with sound.

11. A contactless reader/writer comprising:
a transmission section for transmitting a plurality of transmission signals using carrier waves of different frequencies;
a reception section for receiving a plurality of reply signals which are a response to a plurality of transmission signals transmitted by the transmission section;
a phase calculation section for calculating phase data of the reply signals on the basis of the reply signals; and
a speed calculation section for calculating a frequency component of baseband signals on the basis of the baseband signals acquired from the received signal, and thereby calculating a traveling speed of an object having returned the reply signal on the basis of the frequency component.

12. The contactless reader/writer according to claim 11, wherein whether the object is an RF tag or an obstacle is determined on the basis of whether data is contained in the reply signal or not.

13. The contactless reader/writer according to claim 11, wherein the transmission section is an array antenna.

14. The contactless reader/writer according to claim 11, wherein the transmission section comprises an antenna section having directivity and an antenna driving section for moving the antenna section.

15. The contactless reader/writer according to claim 11, further comprising a display section for displaying position information and/or speed information of an object.

16. The contactless reader/writer according to claim 11, further comprising a sound output section for outputting position information and/or speed information of an object with sound.

17. A contactless reader/writer comprising:
a transmission section for transmitting a plurality of transmission signals using carrier waves of different frequencies;
a reception section for receiving a plurality of reply signals which are a response to a plurality of transmission signals transmitted by the transmission section;
a phase calculation section for calculating phase data of the reply signals on the basis of the reply signals;
a distance calculation section for calculating a distance to an object having returned the reply signal, on the basis of the phase data from the phase calculation section and/or a speed calculation section for calculating a frequency component of baseband signals on the basis of the baseband signals acquired from the received signal, and thereby calculating a traveling speed of an object having returned the reply signal on the basis of the frequency component; and
a control section for controlling a transmission direction of the transmission signals transmitted from the transmission section.

18. The contactless reader/writer according to claim 17, wherein the control section calculates the position of the object on the basis of the transmission direction and the calculation results of the distance calculation section and/or the speed calculation section.

19. The contactless reader/writer according to claim 17, wherein the transmission section is an array antenna.

20. The contactless reader/writer according to claim 17, wherein the transmission section comprises an antenna section having directivity and an antenna driving section for moving the antenna section.

21. The contactless reader/writer according to claim 17, wherein positions of a plurality of the objects are calculated on the basis of the transmission direction and the calculation result of the distance calculation section, whereby a modulation method for the transmission signals transmitted from the transmission section is changed on the basis of the positions of a plurality of the objects and/or the speeds of a plurality of the objects.

22. The contactless reader/writer according to claim 17, wherein positions of a plurality of the objects are calculated on the basis of the transmission direction and the calculation result of the distance calculation section, whereby a packet size of the transmission signals transmitted from the transmission section is changed on the basis of the positions of a plurality of the objects and/or the speeds of a plurality of the objects.

23. The contactless reader/writer according to claim 17, wherein positions of a plurality of the objects are calculated on the basis of the transmission direction and the calculation result of the distance calculation section, whereby a coding method for the transmission signals transmitted from the transmission section is changed on the basis of the positions of a plurality of the objects and/or the speeds of a plurality of the objects.

24. The contactless reader/writer according to claim 17, wherein positions of a plurality of the objects are calculated on the basis of the transmission direction and the calculation result of the distance calculation section, and after that a transmission signal is transmitted to a desired object so that communication is performed with the object.

25. The contactless reader/writer according to claim 17, wherein positions of a plurality of the objects are calculated on the basis of the transmission direction and the calculation result of the distance calculation section, whereby a reply signal from an object in a desired position is validated.

26. The contactless reader/writer according to claim 17, wherein positions of a plurality of the objects are calculated on the basis of the transmission direction and the calculation result of the distance calculation section, whereby communication with objects is stopped when no object is present within a desired area.

27. The contactless reader/writer according to claim 17, wherein positions of a plurality of the objects are calculated on the basis of the transmission direction and the calculation result of the distance calculation section, whereby a transmission signal is transmitted to an object moving at a desired speed so that communication is performed.

28. The contactless reader/writer according to claim 17, wherein positions of a plurality of the objects are calculated on the basis of the transmission direction and the calculation result of the distance calculation section, whereby a reply signal from an object moving at a desired speed is validated.

29. The contactless reader/writer according to claim 17, wherein positions of a plurality of the objects are calculated on the basis of the transmission direction and the calculation result of the distance calculation section, whereby communication is stopped when no object is moving at a desired speed.

30. The contactless reader/writer according to claim 17, wherein positions of a plurality of the objects are calculated on the basis of the transmission direction and the calculation result of the distance calculation section, whereby communication is performed solely with an object present within a desired area and moving at a desired speed.

31. The contactless reader/writer according to claim 17, wherein positions of a plurality of the objects are calculated on the basis of the transmission direction and the calculation result of the distance calculation section, whereby a reply signal from an object present within a desired area and moving at a desired speed is validated.

32. The contactless reader/writer according to claim 17, wherein positions of a plurality of the objects are calculated on the basis of the transmission direction and the calculation result of the distance calculation section, whereby communication is stopped when no object is present within a desired area or when no object is moving at a desired speed.

33. The contactless reader/writer according to claim 17, wherein positions of a plurality of the objects are calculated on the basis of the transmission direction and the calculation result of the distance calculation section, whereby communication is performed sequentially starting with one having the nearest distance among a plurality of the objects, or alternatively communication is performed sequentially starting with one having the farthest distance.

34. The contactless reader/writer according to claim 17, further comprising a display section for displaying position information and/or speed information of an object.

35. The contactless reader/writer according to claim 17, further comprising a sound output section for outputting position information and/or speed information of an object with sound.

36. A contactless reader/writer comprising:
a transmission section for transmitting a plurality of transmission signals using carrier waves of different frequencies;
a reception section for receiving a plurality of reply signals which are a response to a plurality of transmission signals transmitted by the transmission section;
a phase separation section for separating a phase component from each of a plurality of the received signals; and
a distance calculation section for calculating a distance to an object having returned the reply signals, on the basis of the phase components of a plurality of received signals separated by the phase separation section.

37. A contactless reader/writer comprising:
a transmission section for transmitting a plurality of transmission signals using carrier waves of different frequencies;
a reception section for receiving a plurality of reply signals which are a response to a plurality of transmission signals transmitted by the transmission section;
a phase separation section for separating a phase component from each of a plurality of the received signals; and
a speed calculation section for calculating a frequency component of baseband signals on the basis of the baseband signals acquired from the received signal, and thereby calculating a traveling speed of an object having returned the reply signals on the basis of the frequency component.

38. A contactless reader/writer comprising:
a transmission section for transmitting a plurality of transmission signals using carrier waves of different frequencies;
a reception section for receiving a plurality of reply signals which are a response to a plurality of transmission signals transmitted by the transmission section;
a phase calculation section for calculating phase data of the reply signals on the basis of the reply signals;
a data extraction section for receiving an output of the phase calculation section; and
a distance calculation section for calculating a distance to an object having returned the reply signal, on the basis of the output data of the phase calculation section and a phase detection signal outputted from the data extraction section.

39. A contactless reader/writer comprising:
a transmission section for transmitting a plurality of transmission signals using carrier waves of different frequencies;
a reception section for receiving a plurality of reply signals which are a response to a plurality of transmission signals transmitted by the transmission section;
a phase calculation section for calculating phase data of the reply signals on the basis of the reply signals;
a data extraction section for receiving an output of the phase calculation section; and
a speed calculation section for calculating a frequency component of baseband signals on the basis of the baseband signals acquired from the received signal, and thereby calculating a traveling speed of an object having returned the reply signal on the basis of the frequency component.

40. A contactless reader/writer comprising:
a transmission section for transmitting one transmission signal in which a carrier frequency is continuously changed as a function of time;
a reception section for receiving a reply signal which is a response to the transmission signal transmitted by the transmission section; and
a distance calculation section for calculating a frequency component of baseband signals on the basis of the baseband signals acquired from the received signal, then calculating a difference frequency between a frequency of the transmission signal and a frequency of the received signal on the basis of the frequency component, and thereby calculating a distance to an object having returned the reply signal on the basis of the difference frequency component.

41. A contactless reader/writer comprising:
a transmission section for transmitting one transmission signal in which a carrier frequency is continuously changed as a function of time;
a reception section for receiving a reply signal which is a response to the transmission signal transmitted by the transmission section; and
a speed calculation section for calculating a frequency component of baseband signals on the basis of the baseband signals acquired from the received signal, then calculating a difference frequency between a frequency of the transmission signal and a frequency of the received signal on the basis of the frequency component, and thereby calculating a traveling speed of an object having returned the reply signal on the basis of the difference frequency component.
